(19) United States
(12) Patent Application Publication
(10) Pub. No.: US 2025/0179097 A1
(43) Pub. Date: Jun. 5, 2025

(54) END-SUBSTITUTED HETEROACENES WITH PAIRWISE COUPLING IN CRYSTALLINE FORM FOR PURE SPIN POLARIZATION AND OPTICAL READOUT

(71) Applicants: University of Kentucky Research Foundation, Lexington, KY (US); Alliance for Sustainable Energy, LLC, Golden, CO (US)

(72) Inventors: John E. Anthony, Lexington, KY (US); Karl J. Thorley, Lexington, KY (US); Emma K. Holland, Lexington, KY (US); Brandon Rugg, Denver, CO (US); Justin Johnson, Golden, CO (US); Brian Fluegel, Golden, CO (US)

(73) Assignees: University of Kentucky Research Foundation, Lexington, KY (US); Alliance for Sustainable Energy, LLC, Golden, CO (US)

(21) Appl. No.: 18/842,887

(22) PCT Filed: Mar. 2, 2023
(86) PCT No.: PCT/US2023/063583

§ 371 Date: Aug. 30, 2024

Related U.S. Application Data
(60) Provisional application No. 63/315,772, filed on Mar. 2, 2022.

(51) Int. Cl. C07F 7/08; C07F 7/22; C07F 7/30

(52) U.S. Cl. CPC C07F 7/0814; C07F 7/0812; C07F 7/2208; C07F 7/30

(57) ABSTRACT

The present disclosure concerns crystalline pairs of triethylsilyl-ethynyl tetraceno[2,3-b]thiophene and derivatives thereof. The crystallized pairs generate and maintain a high degree of spin polarization that constitutes a qubit. In some aspects, end substitution of a heterocyclic ring with a silicon-based group enforces the necessary pairwise interaction, with larger intermolecular distances between pairs in the crystal that can then produce a parallel alignment of the magnetic axes of all molecules within the crystal unit cell. In addition, end substitution provide energy level alignment between a triplet pair and the emissive singlet state which then allows for low temperature emission from the triplet pair.

### CROSS-REFERENCE TO RELATED APPLICATIONS

This application claims priority to U.S. Provisional Patent Application 63/315,772, filed Mar. 2, 2022, the content of which is hereby incorporated by reference in its entirety.

### CONTRACTUAL ORIGIN

This invention was made with government support under Contract No. DE-AC36-08G028308 awarded by the Department of Energy. The government has certain rights in the invention.

### FIELD OF THE INVENTION

This disclosure relates to a crystalline (hetero)acenes that align as pairs of oriented molecules that undergo singlet fission to generate spin-polarized triplet pairs that have high emission efficiency at low temperature.

### BACKGROUND

Molecular-based quantum bit (qubit) systems are potential alternatives to conventional solid-state spins and superconducting qubits due to operation near room temperature and assembly through deterministic, chemically driven processes. Quantum computation and quantum sensing are two applications that could be advanced by taking advantage of the versatile features of molecular qubits.

Technologies that utilize quantum information (QI) have the potential to transform the fields of computation, sensing, and communications. Still, such applications are currently beyond reach, in large part because of difficulties that prevent sufficient scaling of any materials currently used to store qubits, or units of QI. Research thus far has focused mostly on systems requiring top-down fabrication, which leads to inevitable issues with density and scaling, and production of defects in materials, which are intrinsically stochastic. However, the “bottom-up” approach of designing, synthesizing, and optimizing molecules to serve as spin qubit candidates has already shown great promise in achieving long coherence times, creating extended qubit structures in a controlled fashion, and introducing new varieties of photophysical control.

Among molecular candidates, singlet fission (SF) materials are of worthy of attention as they can form pure, entangled quantum states involving two triplet (T) excitons upon photoexcitation, even at room temperature. Molecules that undergo singlet fission when in a single crystal produce triplet pairs that can be spin-polarized under certain conditions and thus serve as qubits. In addition, an electronic connection between the spin state of the triplet pair and the emissive state can allow for a convenient readout of the spin of the system and can enable integration with a variety of sensing protocols. This is of particular interest, as a major hurdle in developing scalable quantum computing lies in the difficulty in ensuring that qubits are initialized in a pure state prior to computation, which often requires extremely low operating temperatures. In addition to the possibility of selective state formation, the two-exciton states resulting from SF have already shown near-microsecond coherence times. It has also been demonstrated that the polarization of the exciton pair (TT) can be transferred to specific nuclei on the same molecule using controlled microwave pulses, which may allow for a hybrid qubit that takes advantage of the higher polarization and faster manipulability of electron spins and the much longer coherence times of nuclear spins.

To take advantage of these properties, embodiments described herein provide a comprehensive understanding of the underlying spin dynamics of SF. SF takes place after photoexcitation of one member of a chromophore pair to form an excited singlet exciton (S₁+S₀), which can then undergo spin-conserving evolution to the overall singlet ¹(TT), delocalized over both chromophores. The fate of this triplet pair, involving evolution among various triplet pair spin states, is likely to depend critically on the juxtaposition and electronic coupling of the molecules in the system. However, assuming a reasonably strong exchange interaction J between the two triplet excitons, possible spin states include the triplet ³(TT) and quintet ⁵(TT), which have three and five well-defined mₛ sublevels, respectively, in the presence of a strong magnetic field. It has been proposed that fluctuations in J (which dictates the energy splitting between the different spin manifolds) can then cause ¹(TT)↔⁵(TT), which may further evolve to ³(TT) or the spatially separated (T+T). The initial sublevel populations of ⁵(TT) have been analyzed with different approaches, but it is generally agreed upon that the relative molecular orientations of a dimer pair and their orientation relative to an applied magnetic field (B₀) are important factors. The polarization of ⁵(TT) impacts the continued spin evolution of the exciton pair and has been shown to carry over to the isolated triplets in (T+T) after exciton diffusion.

Previous studies using time-resolved electron paramagnetic resonance (TR-EPR) spectroscopy to study and control the spins of (TT) directly have so far only focused on powder samples or partially oriented crystalline films. The resulting lack of complete molecular order leads to two disadvantages, both of which involve the molecular orientation of (TT) relative to B₀. First, the energy of specific spin transitions are orientation dependent, leading to broadening often on the order of 50 mT or more, which leads to significant overlap. Second, as the way in which specific (TT) spin states are populated is also dependent on molecular orientation, a distribution of orientations leads to a mixture of spin state populations. Both disadvantages are not only hurdles for SF materials being utilized for QI applications, but also prevent detailed study of the fundamental spin physics of SF and the resulting (TT) pair.

### SUMMARY

A 1^{st} aspect of the present disclosure, either alone or in combination with any other aspect, concerns a crystalline paired compound, comprising a first compound and a second compound, wherein the first compound comprises a molecule of Formula I or Formula II.

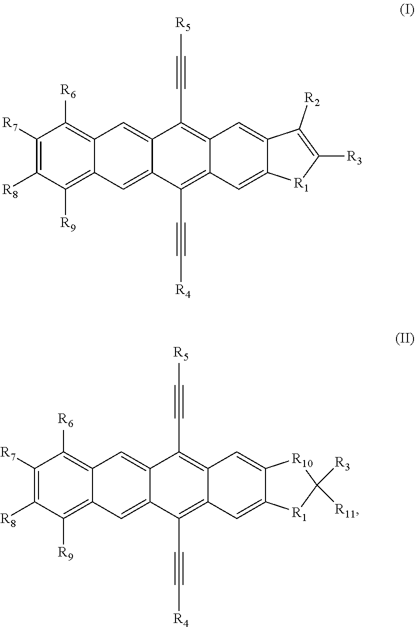

wherein:
R₁ and R₁₀ are independently selected from C, O, S, Se, and N;
R₃ and R₁₁ are independently selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl; and
R₈ is selected —H, —F, —Cl, —Br, —I, or OR₁₂.

A 2^{nd} aspect of the present disclosure, either alone or in combination with any other aspect, concerns the crystalline paired compound of the 1^{st} aspect, wherein the molecule comprises an additional benzene.

A 3^{rd} aspect of the present disclosure, either alone or in combination with any other aspect, concerns the crystalline paired compound of the 2^{nd} aspect, wherein the first compound is of Formula IA or IIA:

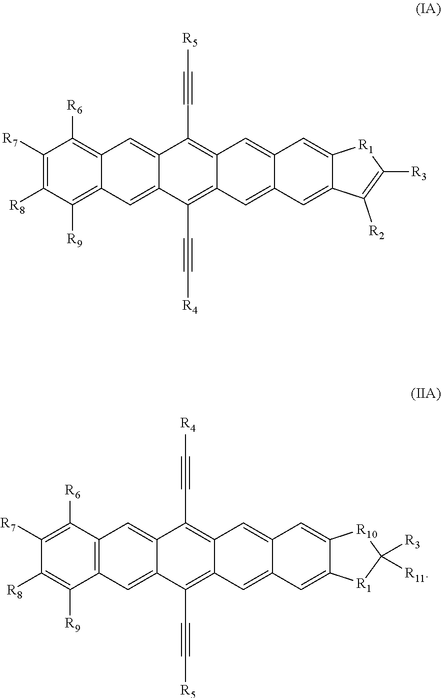

A 4^{th} aspect of the present disclosure, either alone or in combination with any other aspect, concerns the crystalline paired compound of the 1^{st} or 3^{rd} aspect, wherein the first compound is selected from Formula I or IA.

A 5^{th} aspect of the present disclosure, either alone or in combination with any other aspect, concerns the crystalline paired compound of the 4^{th} aspect, wherein: R₁ is selected from C, O, S, Se, and N; R₂ is selected from —H, —F, —Cl, —Br, —I, and CH₃ R₃ is selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group; R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group; R₆ and R₉ are independently selected from H, —F, —Cl, —Br, —I, —OH, and —OR₁₂, wherein R₁₂ is an alkyl chain of between 1 and 6 carbons in length; R₇ is from —H, —F, —Cl, —Br, and —I, a small branched alkyl, an alkyl carbinol or ether thereof, a trialkylsilyl, a trialkylgermyl, and a trialkylstannyl; and R₈ is selected —H, —F, —Cl, —Br, or —I,

A 6th aspect of the present disclosure, either alone or in combination with any other aspect, concerns the crystalline paired compound of the 4^{th} aspect, wherein R₃ is a triethylsilyl, a triethylgermyl, or a triethyl stannyl.

A 7th aspect of the present disclosure, either alone or in combination with any other aspect, concerns the crystalline paired compound of the 4′ aspect, wherein R₃ is a triethylsilyl, a triethylgermyl, or a triethyl stannyl and R₆, R₇. R₈, and R₉ are hydrogen.

An 8^{th} aspect of the present disclosure, either alone or in combination with any other aspect, concerns the crystalline paired compound of the 4^{th} aspect, wherein R₃ is a triethylsilyl, a triethylgermyl, or a triethyl stannyl; R₂, R₆, R₇. R₈, and R₉ are hydrogen; and R₁ is O or S.

A 9^{th} aspect of the present disclosure, either alone or in combination with any other aspect, concerns the crystalline paired compound of the 4^{th} aspect, wherein R₄ and R₅ are triisopropylsilyl, triisopropylgermyl, or triisopropyl stannyl.

A 10^{th} aspect of the present disclosure, either alone or in combination with any other aspect, concerns the crystalline paired compound of the 4′ aspect, wherein R₃ is a triethylsilyl, a triethylgermyl, or a triethyl stannyl; R₂, R₆, R₇. R₈, and R₉ are hydrogen; R₁ is O or S; and R₄ and R₅ are triisopropylsilyl, triisopropylgermyl, or triisopropyl stannyl.

An 11^{th} aspect of the present disclosure, either alone or in combination with any other aspect, concerns the crystalline paired compound of the 1^{st} or 3^{rd} aspect, wherein the first compound is selected from Formula II or IIA.

A 12^{th} aspect of the present disclosure, either alone or in combination with any other aspect, concerns the crystalline paired compound of the 11^{th} aspect, wherein: R₃ and R₁₁ are independently selected from a straight alkyl, a branched alkyl an aryl, or a vinyl group; R₄ and R₅ are chosen from a trialkylsilyl, a trialkylgermyl, a trialkylstannyl, or a tert-butyl group; R₆, R₇, R₈, and R₉ are independently chosen from —H, —F, —Cl, —Br, —I, or OR₁₂, wherein R₁₂ is an alkyl chain of between 1 and 6 carbons in length.

A 13^{th} aspect of the present disclosure, either alone or in combination with any other aspect, concerns the crystalline paired compound of the 11^{th} aspect, wherein R₃ and R₁₁ are isobutyl.

A 14^{th} aspect of the present disclosure, either alone or in combination with any other aspect, concerns the crystalline paired compound of the 11^{th} aspect, wherein R₃ and R₁ are isobutyl and R₆, R₇. R₈, and R₉ are hydrogen.

A 15^{th} aspect of the present disclosure, either alone or in combination with any other aspect, concerns the crystalline paired compound of the 11^{th} aspect, wherein R₄ and R₅ are triisopropylsilyl, triisopropylgermyl, or triisopropyl stannyl.

A 16^{th} aspect of the present disclosure, either alone or in combination with any other aspect, concerns the crystalline paired compound of the 11^{th} aspect, wherein R₄ and R₅ are triisopropylsilyl, triisopropylgermyl, or triisopropyl stannyl; R₃ and R₁ are isobutyl; and, R₆, R₇. R₈, and R₉ are hydrogen.

A 17^{th} aspect of the present disclosure, either alone or in combination with any other aspect, concerns the crystalline paired compound of the 1^{st} or 3^{rd} aspect, wherein if R₃ is hydrogen, then R₇ is selected from a small branched alkyl, an alkyl carbinol or ether thereof, a trialkylsilyl, a trialkylgermyl, and a trialkylstannyl.

An 18^{th} aspect of the present disclosure, either alone or in combination with any other aspect, concerns the crystalline paired compound of the 1^{st} or 3^{rd} aspect, wherein the second compound is identical to the first compound.

A 19^{th} aspect of the present disclosure, either alone or in combination with any other aspect, concerns the crystalline paired compound of the 1^{st} or 3^{rd} aspect, wherein the second compound comprises Formula III:

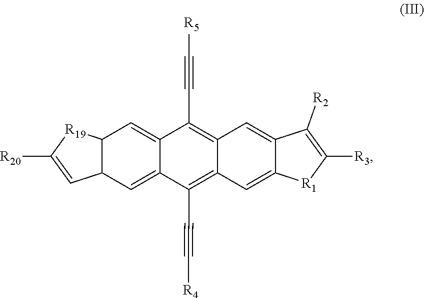

and
wherein: R₁ and R₁₉ are independently selected from C, O, S, Se, and N; R₂ is selected from —H, —F, —Cl, —Br, —I, and CH₃; R₃ is selected from —H, a branched alkyl (C₄-C₁₂), an alkyl carbinol (C₄-C₁₂) or ether thereof, a trialkylsilyl, a trialkylgermyl, or a trialkylstannyl group; R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and R₂₀ is selected from —H, —F, —Cl, —Br, and —I.

A 20^{th} aspect of the present disclosure, either alone or in combination with any other aspect, concerns a crystalline paired compound comprising a first compound and a second compound, wherein the first compound comprises a molecule of Formula III or IIIA:

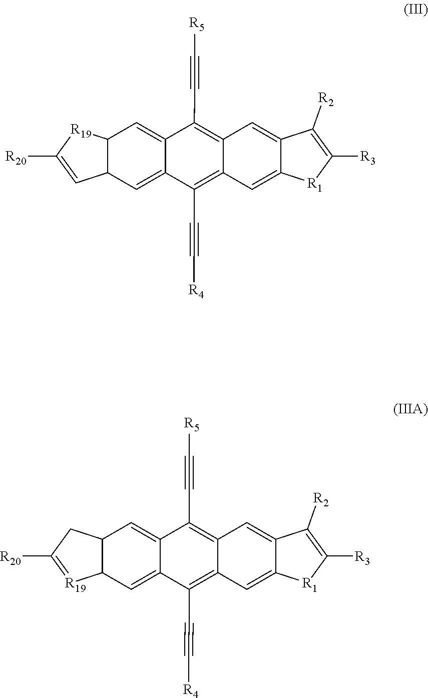

wherein: R₁ and R₁₉ are independently selected from C, O, S, Se, and N; R₂ is selected from —H, —F, —Cl, —Br, —I, and CH₃; R₃ is selected from —H, a branched alkyl (C₄-C₁₂), an alkyl carbinol (C₄-C₁₂) or ether thereof, a trialkylsilyl, a trialkylgermyl, or a trialkylstannyl group; R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and R₂₀ is selected from —H, —F, —Cl, —Br, and —I.

A 21^{st} aspect of the present disclosure, either alone or in combination with any other aspect, concerns the crystalline paired compound of the 20^{th} aspect, wherein the second compound is of Formula IIIA if the first compound is of Formula III.

A 22^{nd} aspect of the present disclosure, either alone or in combination with any other aspect, concerns the crystalline paired compound of the 20^{th} aspect, wherein the second compound is of the same formula as the first compound.

A 23^{rd} aspect of the present disclosure, either alone or in combination with any other aspect, concerns a crystalline paired compound comprising a crystalline paired compound, comprising a first compound and a second compound, wherein the first compound comprises a molecule of Formula IV, V, or VI.

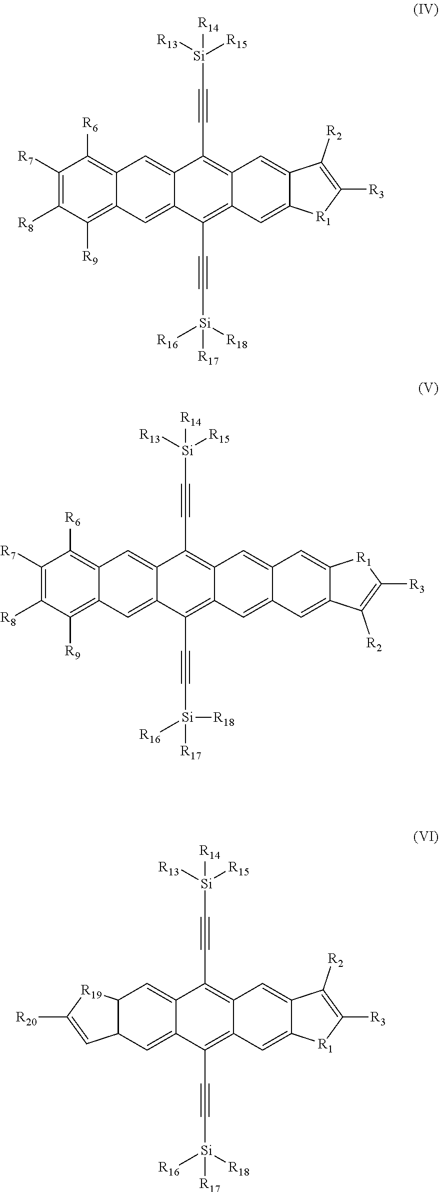

wherein: R₁ and R₁₉ are independently selected from C, O, S, Se, and N; R₂ is selected from —H, —F, —Cl, —Br, —I, and CH₃; R₃ is selected from —H, a branched alkyl (C₄-C₁₂), an alkyl carbinol (C₄-C₁₂) or ether thereof, a trialkylsilyl, a trialkylgermyl, or a trialkylstannyl group; R₆ and R₉ are independently selected from H, —F, —Cl, —Br, —I, —OH, and —OR₁₂, wherein R₁₂ is an alkyl chain of between 1 and 6 carbons in length; R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl; R₈ is selected —H, —F, —Cl, —Br, —I, or OR₁₂; and, Rn, R₁₄, R₁₅, R₁₆, R₁₇, and R₁₈ are independently selected from a straight alkyl (C₄-C₁₂) and a branched alkyl (C₄-C₁₂), or a combination thereof.

A 24^{th} aspect of the present disclosure, either alone or in combination with any other aspect, concerns the crystalline paired compound of the 23^{rd} aspect, wherein at least one of R₁₃, R₁₄, R₁₅, R₁₆, R₁₇, and R₁₈ is an isopropyl.

A 25^{th} aspect of the present disclosure, either alone or in combination with any other aspect, concerns the crystalline paired compound of the 23^{rd} aspect, wherein all of R₁₃, R₁₄, R₁₅, R₁₆, R₁₇, and R₁₈ are isopropyl.

A 26^{th} aspect of the present disclosure, either alone or in combination with any other aspect, concerns the crystalline paired compound of the 23^{rd} aspect, wherein R₃ is a triethylsilyl, a triethylgermyl, or a triethyl stannyl.

A 27^{th} aspect of the present disclosure, either alone or in combination with any other aspect, concerns the crystalline paired compound of the 23^{rd} aspect, wherein R₃ is a triethylsilyl, a triethylgermyl, or a triethyl stannyl and R₆, R₇. R₈, and R₉ are hydrogen.

A 28^{th} aspect of the present disclosure, either alone or in combination with any other aspect, concerns a crystalline paired compound comprising a first compound and a second compound, wherein the first compound comprises a molecule of Formula VIII:

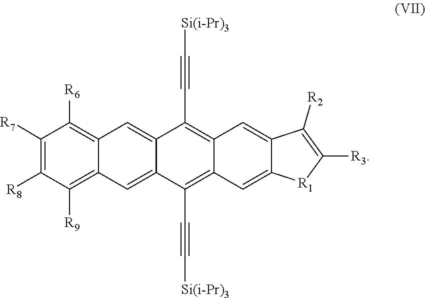

A 29^{th} aspect of the present disclosure, either alone or in combination with any other aspect, concerns the crystalline paired compound of the 28^{th} aspect, wherein R₃ is a triethylsilyl, a triethylgermyl, or a triethyl stannyl.

A 30^{th} aspect of the present disclosure, either alone or in combination with any other aspect, concerns the crystalline paired compound of the 28^{th} aspect, wherein R₃ is a triethylsilyl, a triethylgermyl, or a triethyl stannyl and R₆, R₇. R₈, and R₉ are hydrogen.

A 31^{st} aspect of the present disclosure, either alone or in combination with any other aspect, concerns the crystalline paired compound of the 28^{th} aspect, wherein the first compound comprises Formula VIII:

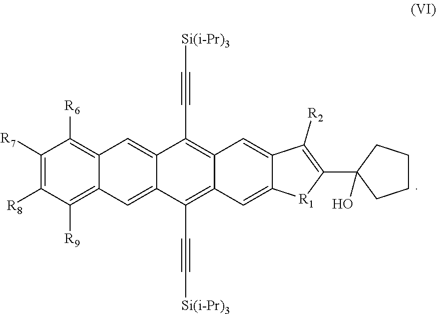

A 32^{nd} aspect of the present disclosure, either alone or in combination with any other aspect, concerns a crystalline paired compound comprising a first compound and a second compound, wherein the first compound comprises a molecule of Formula IX or X:

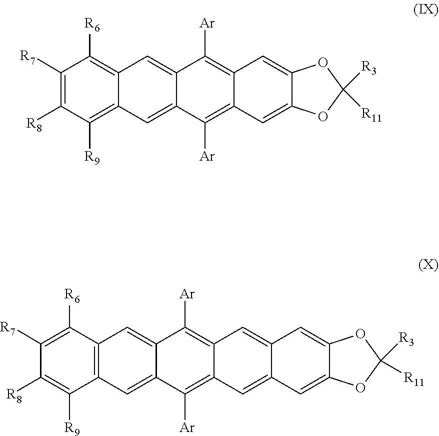

wherein: R₁ and R₁₀ are oxygen; R₃ and R₁₁ are independently selected from a straight alkyl, a branched alkyl, an aryl, or a vinyl group; each Ar is independently chosen from a functionalized aryl or heteroaryl group; and R₆, R₇, R₈, and R₉ are independently chosen from —H, —F, —Cl, —Br, —I, or OR₁₂, wherein R₁₂ is an alkyl chain of between 1 and 6 carbons in length.

A 33^{rd} aspect of the present disclosure, either alone or in combination with any other aspect, concerns a molecular-based quantum bit (qubit) system comprised of any crystalline compound pairs of aspects 1-32.

### BRIEF DESCRIPTION OF THE DRAWINGS

FIG. 1A depicts the crystal structure of TES TIPSTT from the view along the a-axis, with the (0 1-1) face indicated by a red line. The S atoms in both molecules appear on either side of the thiophene ring with a substantially equal likelihood. H atoms are hidden.

FIG. 1B shows representative picture of a TES TIPSTT crystal, which typically forms a lath-shaped crystal with its major face aligned with the (0 1-1) plane and its long axis equivalent to the a-axis of the crystal structure.

FIG. 2A shows dimer pairs for which exchange couplings were calculated. Dimers a and b differ in the modeled disposition of sulfur atoms in the crystal structure. All images are shown with the ring perpendicular axes coming out toward the viewer.

FIG. 2B shows dimer pairs for which exchange couplings were calculated. The dime in 2B differs from 2A in the modeled disposition of sulfur atoms in the crystal structure. All images are shown with the ring perpendicular axes coming out toward the viewer.

FIG. 2C shows a further dimer pair for which exchange couplings were calculated.

FIG. 2D shows a further dimer pair for which exchange couplings were calculated.

FIG. 3A depicts energy level diagram of an exciton pair for J=−15.3 GHz in a magnetic field, a value determined by results from 3B. Black circles highlight field strengths at level crossings between 1(TT) and ⁵(TT)_{+1,+2} occur, which would explain the observed peak pattern of relative decreases in PL. Crossing with ³(TT)₊₁ is also shown, though there is not an associated peak.

FIG. 3B shows detected changes in relative PL vs. applied magnetic field. The inset shows the same experiment at a wider magnetic field range, which shows no additional well-defined structure.

FIG. 4A depicts TR-EPR spectra of TES TIPSTT after □ₑₓ=610 nm in a 4:1 mixture of iodobutane/toluene at 100 K, averaged between 900-1800 ns and

FIG. 4B depicts spectra crystalline powder of TES TIPSTT at room temperature at early and late times (25-75 and 400-425 ns, respectively).

FIG. 5A depicts TR-EPR spectra of a single crystal of TES TIPSTT mounted to enable rotation of the molecular x′- and z′-axis in the plane of B₀ at early (25-75 ns) times. The starting orientation of 0° represents the orientation in which z′∥B₀.

FIG. 5B depict TR-EPR spectra of a single crystal of TES TIPSTT mounted to enable rotation of the molecular x′- and z′-axis in the plane of B₀ at late (400-450 ns) times. The starting orientation of 0° represents the orientation in which z′∥B₀.

FIG. 6A depicts normalized kinetics at field positions where the ⁵(TT)₀→⁵(TT)₊₁ and free triplet T₀→T₊ transitions are expected to occur at z′∥B₀ and orientation.

FIG. 6B depicts normalized kinetics at field positions where the ⁵(TT)₀→⁵(TT)₊₁ and free triplet T₀→T₊ transitions are expected to occur at x′∥B₀ orientation.

FIG. 7 shows a sketch of experimental setup for broadband ODMR study of organic semiconductors using non-resonant surface-loop coil. The sample is illuminated by 532 nm laser light and photoluminescence (PL) is collected by lenses and avalanche photodiode (APD) is used as detector. The cw ODMR spectra are collected by lock-in detection scheme with microwave amplitude modulation.

FIG. 8 shows photoluminescence spectra of TES-TIPS TT at room temperature and low temperature. The ODMR spectra are measured with 700 nm long pass filter as shown in blue spectrum. This band emerges as a result of singlet fission process in the organic semiconductor.

FIG. 9 shows ODMR at zero-field reveals the information about zero-field splitting parameters D and E.

FIG. 10 shows ODMR at 3 GHz obtained by lock-in detection scheme with amplitude modulation at 100 Hz.

FIG. 11 shows magnetic field effect (MFE) on the photoluminescent intensity of TES-TIPS TT.

FIG. 12 shows how the compounds of the present disclosure adopt the desired crystal packing. Depicted is the pairwise stacking, along with just the solubilizing groups from adjacent stacks insulating top and bottom.

FIG. 13 shows a more detailed top view of the compound depicted in FIG. 12.

### DETAILED DESCRIPTION

In some aspects, the present disclosure concerns the identification that unsymmetrical end-substitution of the heterocyclic ring of a (hetero)acene provides compounds that when crystallized generate and maintain a high degree of spin polarization. In some aspects, the present disclosure concerns end substitution of a heterocyclic ring of a (hetero)acene with a sterically large group. In further aspects, the present disclosure concerns end substitution of a trialkylsilylethynyl heterocyclic ring with a silicon-based group. In some aspects, the (hetero)acene includes, triethylsilyl-ethynyl tetraceno[2,3-b]thiophene TES TIPS-TT and derivatives thereof. As set forth herein, a time resolved electron paramagnetic resonance (TR-EPR) study of a single crystal of TES TIPS-TT was conducted. TES-TIPS-TT is a novel (hetero)acene with a crystal structure in which all molecules share a common molecular axis, apart from 180° rotations. The macroscopic properties of the TES TIPS-TT crystal also permit facile identification of the a-axis of the unit cell as well as the (0 1-1) and (0-1 1) faces of the crystal, which allows for samples to be prepared with the molecular z′-axis systematically controlled relative to B₀. The orientation of the z′-axis, which lies perpendicular to the molecular □-system, has the largest effect on the splitting between the various T and (TT) TR-EPR transitions and is also thought to have the greatest influence on the spin evolution of (TT) in a magnetic field.

The TR-EPR spectra show conclusive signatures of the coupled ⁵(TT) pair, which were not observed in a similar study of SF in a single crystal of tetracene. To a great degree, the impact of the orientation of z′ relative to B₀ on the resulting spin sublevel population is clearly discernable by the change in the sign and amplitude of various transitions associated with ⁵(TT) and the diffuse (T+T) at different crystal orientations. The analysis of associated sublevel populations was further facilitated by experimental determination of the magnitude of J with a magnetophotoluminescence (MPL) experiment. Data from the MPL experiment indicates the presence of a dimer with an intermediate exchange coupling that permits mixing between the ⁵(TT) and ³(TT) spin manifolds leading to atypical spin state populations. Overall, these results demonstrate the advantages of studying well-ordered crystals of SF materials.

In some aspects, the present disclosure concerns crystals of the end-substituted compounds disclosed herein. In some aspects, the end substitution of a heterocyclic ring with a silicon-based group enforces pairwise interactions, leading to larger intermolecular distances between the paired chromophores in the crystal than what is present in other heterocyclic acene compounds. This can then produce a parallel alignment of the magnetic axes of all molecules within the crystal unit cell. These features are important for generating and maintaining a high degree of the spin polarization that constitutes the qubit. In addition, end substitution can provide energy level alignment between a triplet pair and the emissive singlet state, which then allows for low temperature emission from the triplet pair.

In some aspects, the present disclosure concerns compounds with a multi-acene backbone, such as a tetracene or a pentacene backbone. In some aspects, the multi-acene compounds include one or two five membered termini or end substitutions to the backbone, such as a cyclopentadienyl, furan, thiophene, selenophene, pyrrole, or other substituted five-membered ring. In some aspects, the compounds of the present disclosure are crystallized to provide a high degree of spin polarization.

In some aspects, the present disclosure concerns crystalline paired compounds of Formula I or II:

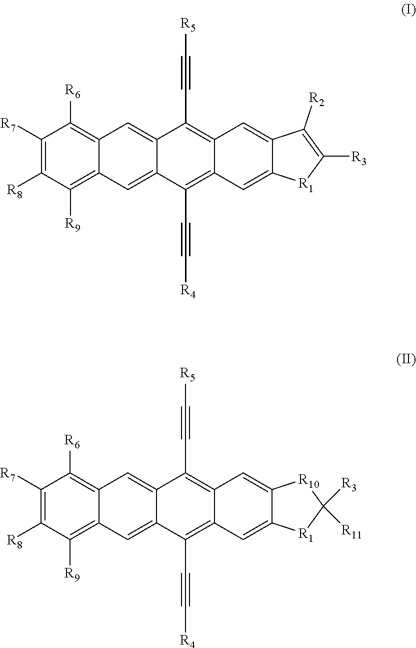

wherein:
R₁ and R₁₀ are independently selected from C, O, S, Se, and N;
R₃ and R₁₁ are independently selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl; and R₈ is selected —H, —F, —Cl, —Br, —I, or OR₁₂.

In some aspects, if R₃ is hydrogen, then R₇ is selected from a small branched alkyl, an alkyl carbinol or ether thereof, a trialkylsilyl, a trialkylgermyl, and a trialkylstannyl.

In some aspects, R₃ is a triethylsilyl, a triethylgermyl, or a triethyl stannyl.

In some aspects, R₃ is a triethylsilyl, a triethylgermyl, or a triethyl stannyl and R₆, R₇. R₈, and R₉ are hydrogen.

In some aspects, the compounds of Formulas I and II may include an additional aromatic ring in the backbone, such as from a tetracene to a pentacene, as set forth in Formulas IA and IIA:

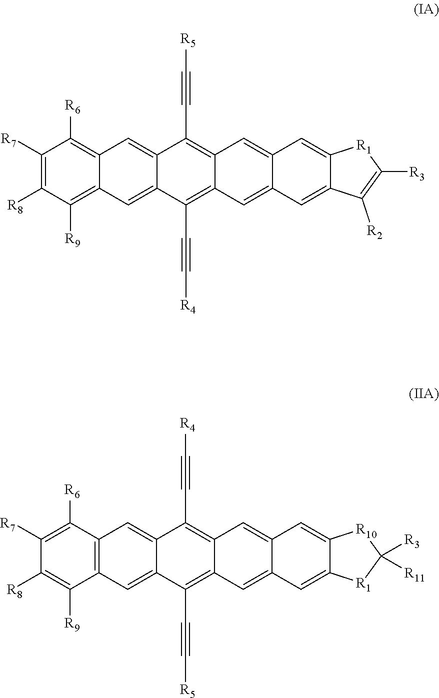

In some aspects, the present disclosure concerns crystalline paired compounds of Formula I and IA, wherein:
R₁ is selected from C, O, S, Se, and N;
R₂ is selected from —H, —F, —Cl, —Br, —I, and CH₃
R₃ is selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, an alkyl carbinol or ether thereof, a trialkylsilyl, a trialkylgermyl, and a trialkylstannyl; and
R₈ is selected —H, —F, —Cl, —Br, or —I,

In some aspects, if R₃ is hydrogen, then R₇ is selected from a small branched alkyl, an alkyl carbinol or ether thereof, a trialkylsilyl, a trialkylgermyl, and a trialkylstannyl.

In some aspects, R₃ is a triethylsilyl, a triethylgermyl, or a triethyl stannyl.

In some aspects, R₃ is a triethylsilyl, a triethylgermyl, or a triethyl stannyl and R₆, R₇. R₈, and R₉ are hydrogen.

In some aspects, R₃ is a triethylsilyl, a triethylgermyl, or a triethyl stannyl; R₂, R₆, R₇. R₈, and R₉ are hydrogen; and R₁ is O or S.

In some aspects, R₄ and R₅ are triisopropylsilyl, triisopropylgermyl, or triisopropyl stannyl.

In some aspects, R₃ is a triethylsilyl, a triethylgermyl, or a triethyl stannyl; R₂, R₆, R₇. R₈, and R₉ are hydrogen; R₁ is O or S; and R₄ and R₅ are triisopropylsilyl, triisopropylgermyl, or triisopropyl stannyl.

In some aspects, the present disclosure concerns crystalline paired compounds of Formula II and IIA, wherein
R₁ and R₁₀ are oxygen;
R₃ and R₁₁ are independently selected from a straight alkyl, a branched alkyl an aryl, or a vinyl group;
R₄ and R₅ are chosen from a trialkylsilyl, a trialkylgermyl, a trialkylstannyl, or a tert-butyl group;
R₆, R₇, R₈, and R₉ are independently chosen from —H, —F, —Cl, —Br, —I, or OR₁₂, wherein wherein R₁₂ is an alkyl chain of between 1 and 6 carbons in length.

In some aspects, R₃ and R₁ are isobutyl. In some aspects, R₃ and R₁ are isobutyl and R₆, R₇. R₈, and R₉ are hydrogen.

In some aspects, R₄ and R₅ are triisopropylsilyl, triisopropylgermyl, or triisopropyl stannyl.

In some aspects, R₄ and R₅ are triisopropylsilyl, triisopropylgermyl, or triisopropyl stannyl; R₃ and R₁ are isobutyl; and, R₆, R₇. R₈, and R₉ are hydrogen.

In some aspects, the terminal aromatic ring may be end substituted at both ends of the backbone. In some aspects, the present disclosure concerns crystalline compounds of Formula III:

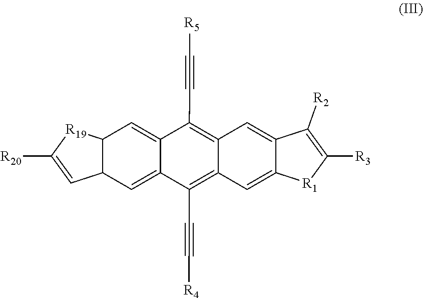

wherein:
R₁ and R₁₉ are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and
R₂₀ is selected from —H, —F, —Cl, —Br, and —I.

In the di(hetero)acene, the heteroatoms R₁ and R₁₉ may adopt the shown anti configuration, as shown for formula III, or may adopt a syn conformation, where R₁ and R₁₉ are on the same edge of the (hetero)acene as set forth in Formula IIIA:

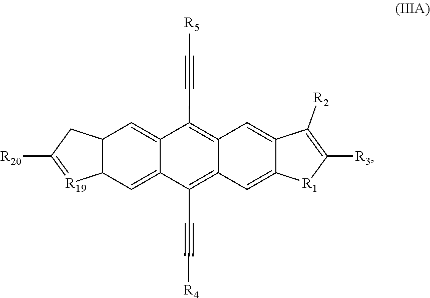

wherein:
R₁ and R₁₉ are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and
R₂₀ is selected from —H, —F, —Cl, —Br, and —I.
   Mixtures of syn and anti are also acceptable formulations.

In some aspects, the present disclosure concerns trialkylsilyl end substitutions on a heterocyclic ring of a (hetero)acene. In some aspects, one of R₃ and R₇ is a trialkylsilyl. In some aspects, the present disclosure concerns compounds of Formulas IV, V, and VI:

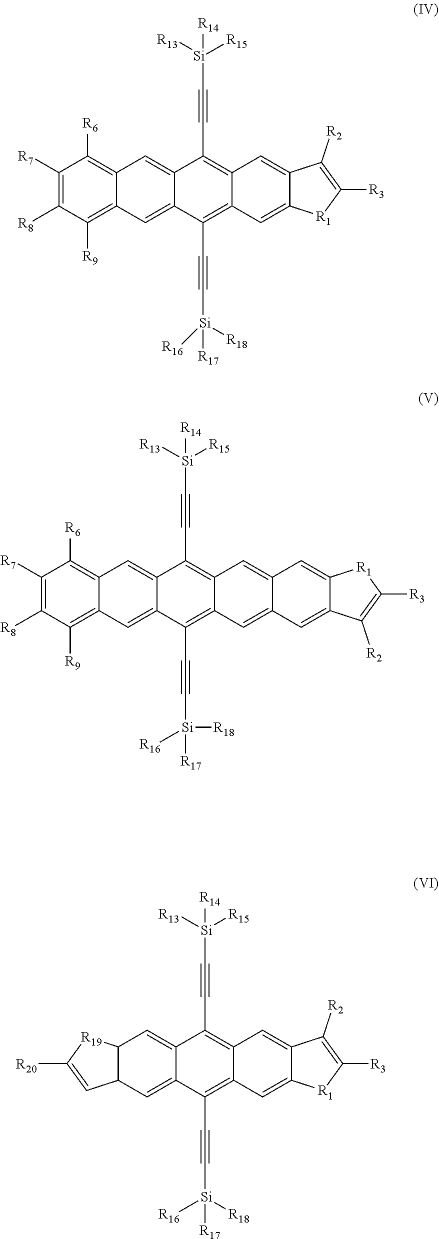

wherein:
R₁ and R₁₉ are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl;
R₈ is selected —H, —F, —Cl, —Br, —I, or OR₁₂; and,
R₁₃, R₁₄, R₁₅, R₁₆, R₁₇, and R₁₈ are independently selected from a straight alkyl (C₄-C₁₂) and a branched alkyl (C₄-C₁₂), or a combination thereof.

In some aspects, at least one of R₁₃, R₁₄, R₁₅, R₁₆, R₁₇, and R₁₈ is an isopropyl. In further aspects, all of R₁₃, R₁₄, R₁₅, R₁₆, R₁₇, and R₁₈ are isopropyl.

In certain aspects, the compounds of the present disclosure concern those encompassed by Formula VII:

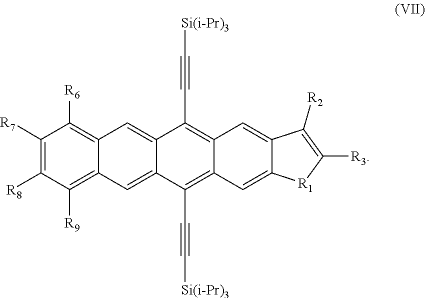

In some aspects, the present disclosure concerns a compound with the Formula VIII.

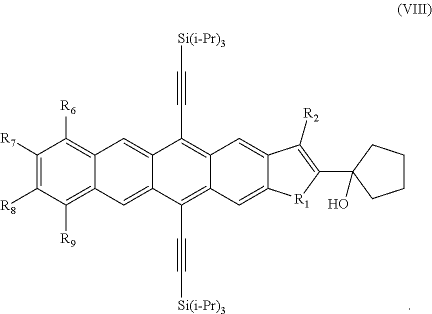

In some aspects, the present disclosure concerns preparing a crystal from one or more of the compounds as set forth herein. In some aspects, the crystal be of a compound encompassed by Formula I or Formula IA or Formula II or Formula IIA or Formula III or Formula IIIA. In other aspects, the crystal is of a compound encompassed by Formula IV or Formula V or Formula VI. In certain aspects, the crystal is of a compound encompassed by Formula VII or Formula VIII.

In some aspects, the present disclosure concerns crystals of compounds encompassed by Formula VII. In some aspects, the present disclosure concerns crystals of Formula VII, wherein at least one of R₂, R₆, R₇, R₈, and R₉ is a hydrogen. In certain aspects, the present disclosure concerns crystals of Formula VI, wherein R₂, R₆, R₇, R₈, and R₉ are all hydrogen.

In some aspects, the present disclosure concerns crystalline paired compounds of Formula II or IIA:

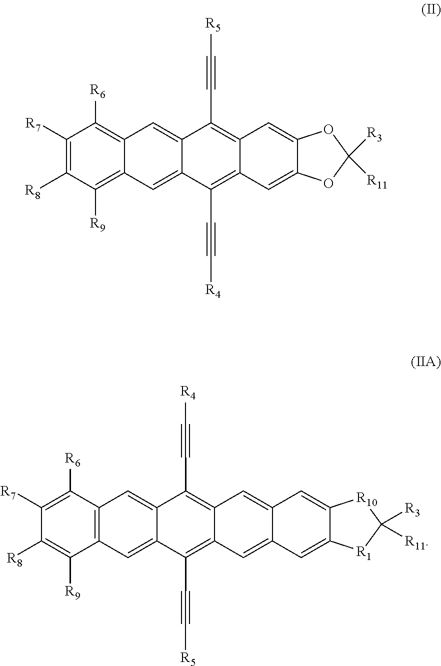

wherein:
R₁ and R₁₀ are oxygen;
R₃ and R₁₁ are independently selected from a straight alkyl, a branched alkyl, an aryl, or a vinyl group;
R₄ and R₅ are chosen from a trialkylsilyl, a trialkylgermyl, a trialkylstannyl, or aa tert-butyl group;
R₆, R₇, R₈, and R₉ are independently chosen from —H, —F, —Cl, —Br, —I, or OR₁₂, wherein R₁₂ is an alkyl chain of between 1 and 6 carbons in length.

In some aspects, the present disclosure concerns crystalline paired compounds of Formula IX or X:

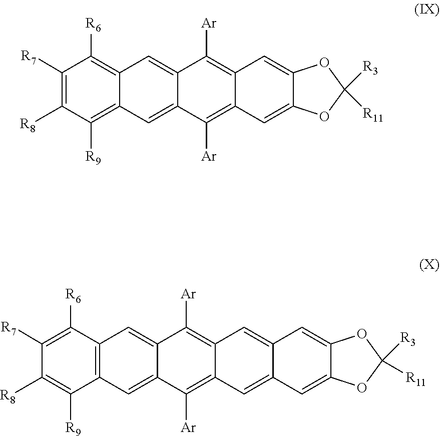

wherein:
R₁ and R₁₀ are oxygen;
R₃ and R₁₁ are independently selected from a straight alkyl, a branched alkyl, an aryl, or a vinyl group;
Each Ar is independently chosen from a functionalized aryl or heteroaryl group; and
R₆, R₇, R₈, and R₉ are independently chosen from —H, —F, —Cl, —Br, —I, or OR₁₂, wherein R₁₂ is an alkyl chain of between 1 and 6 carbons in length.

In some aspects, R₃ and R₁₁ are isobutyl. In some aspects, R₃ and R₁₁ are isobutyl and R₆, R₇. R₈, and R₉ are hydrogen.

In some aspects, the present disclosure concerns preparing a crystal from one or more of the compounds as set forth herein. In some aspects, the crystal be of a compound encompassed by Formula II or IIA. In other aspects, the crystal is of a compound encompassed by Formula VIII or IX.

In some aspects, and by way of example only, the compounds for crystallization as described herein, may be chosen from:

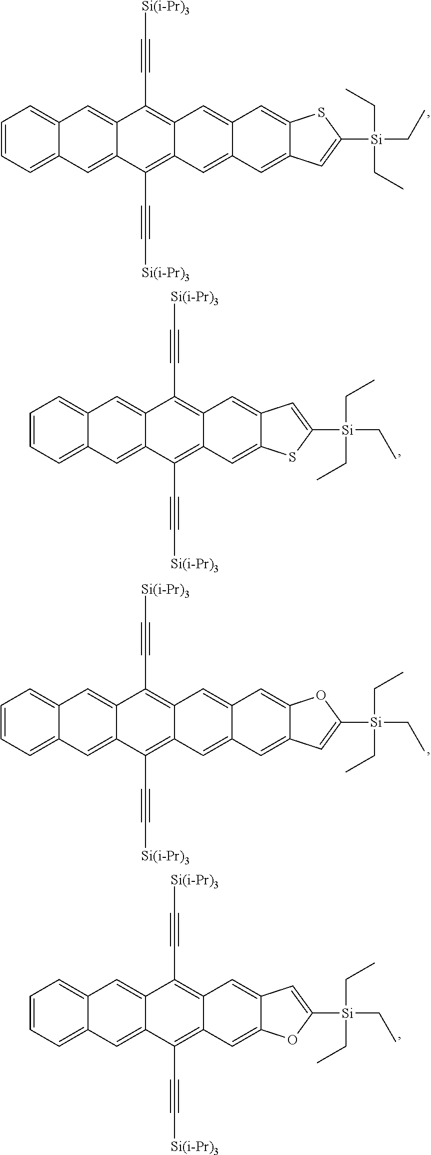

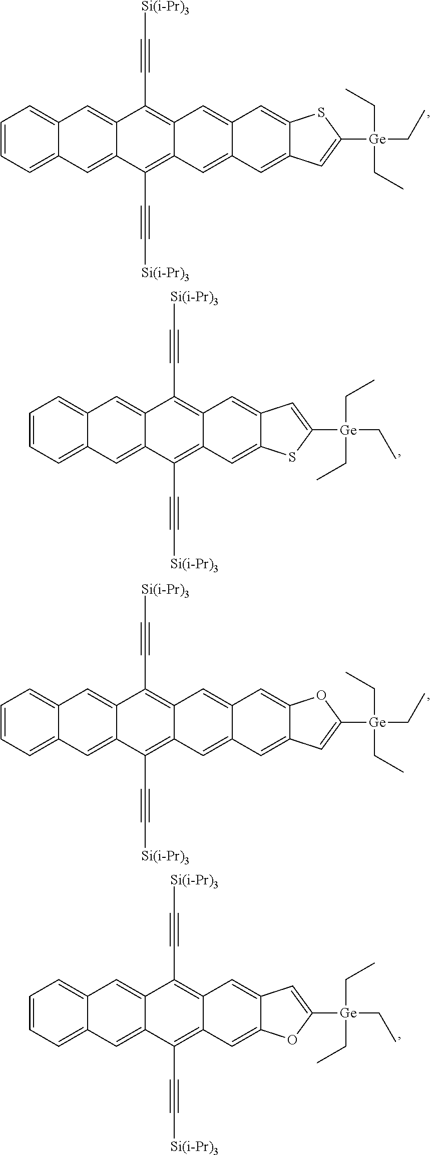

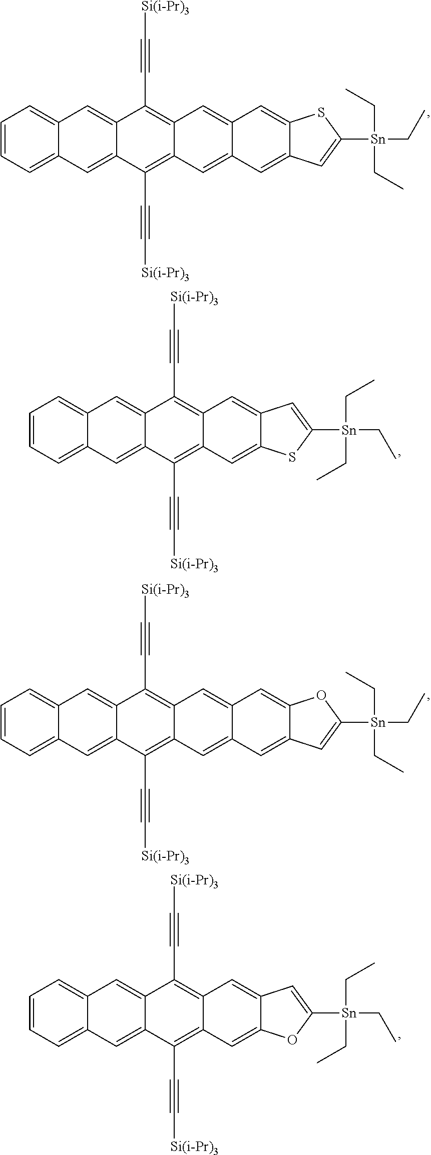

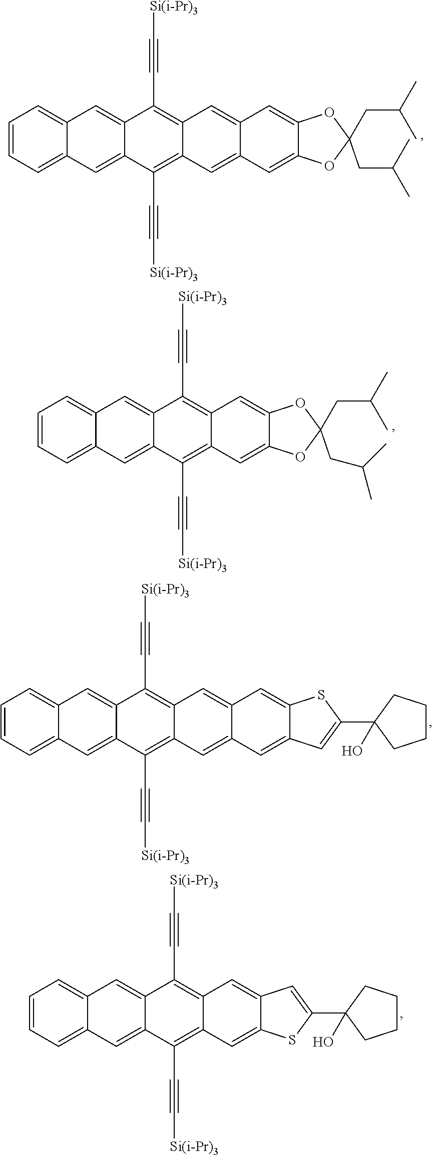

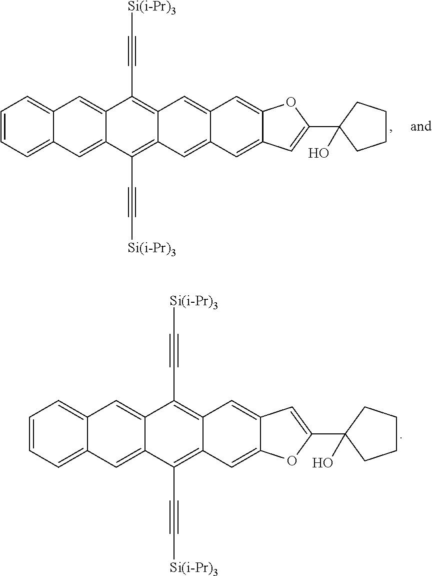

As set forth herein, when the compounds of the present disclosure are crystallized, the end substitution enforces a pairwise intermolecular interaction with a parallel alignment of the magnetic axes of all the molecules within the crystal. The alignment then allows for the generation and maintenance of a high degree of spin polarization, thereby providing a qubit.

In some aspects, the crystalline compounds as set forth herein are utilized or further processed to be utilized as a quibit. In some aspects, an electrical field or charge may be applied thereto. In some aspects, one or more of the crystalline compounds of the present disclosure may be operably connected to an electrical source or source of electrical power. In some aspects, the crystalline compounds of the present disclosure may be integrated into an electrical circuit, whereby the crystalline compound of the present disclosure is operably connected to an electrical source and/or an electrically conductive material. In some aspects, two or more crystals of the crystalline compounds of the present disclosure may be arranged on the surface of chip connected with a conductive material to directly or indirectly receive an electrical charge and/or communicate or relay a signal with a neighboring crystal.

In some aspects, the present disclosure concerns methods using the crystals, such as through application of an electrical charge or connecting the crystal pairs to an electrical source.

In some aspects, the present disclosure concerns method of preparing the paired crystals. The syntheses of silylethyne-substituted heteroacenes are understood in the literature (see for example M. L. Tang, A. D. Reichardt, T. Siegrist, S. C. B. Mannsfeld, Z. Bao Chem. Mater. 2008, 20, 4669). To a solution of the desired heteroacene dissolved in anhydrous tetrahydrofuran at a concentration of 1.0-0.1 M, stirred under nitrogen and cooled to 0° C. is added 1.1 molar equivalents of a solution of lithium diisopropylamide (either purchased commercially from e.g. Sigma-Aldrich, or made by deprotonating diisopropylamine with n-butyllithium in the usual manner). After stirring at 0° C. for 2 hours, 1.2 molar equivalents of the desired electrophile (chloro silane, germane, stannane, or a ketone such as cyclopentanone) are added, and the solution is then allowed to warm to room temperature and stirred for 2-48 hours. The reaction mixture is poured into hexanes and extracted repeatedly with water. The organic solution is then dried (magnesium or sodium sulfate) and the solvent removed. The resulting molecule is purified by chromatography with silica gel, and then by recrystallization.

Dioxolane-pentacene synthesis can be achieved through a 2 step process via a dioxolane-quinone. For example, 2,2-isobutyl Anthra[2,3-d]-1,3-dioxole-6,9-dione [M. Bruzek and J. E. Anthony, Organic Letters (2014), 16(13), 3608-3610](1.50 g, 4.11 mmol) and α,α,α′,α′-Tetrabromo-o-xylene (1.74 g, 4.11 mmol) can be dissolved in dimethylacetamide (10 mL) in a pressure tube. The reaction mixture then purged with N₂ gas, and then Potassium Iodide added and the reaction sealed. The reaction mixture can then be stirred at temperature of about 180° C. for an extended period of time, such as 48 hours. Returning to room temperature, the reaction can then be quenched with water and the solid collected by vacuum filtration. The solid may then be washed such as with acetone and/or diethyl ether and then transferred to be triturated with acetone, and then left to stand at room temperature for 48 hours. The solid may then be collected by vacuum filtration.

Next, triisopropylsilyl acetylene can be dissolved in hexanes (50 mL) and cooled to 0° C. n-Butyllithium isd then added slowly, and the reaction mixture stirred for 1 hour at 0° C. Dioxolane quinone is then added, and the reaction stirred for 16 hours at room temperature. The reaction is then quenched by addition of a few drops of saturated NH₄Cl(aq) solution, and the mixture poured onto a silica plug. The excess acetylene can be eluted with hexanes, and then the pentacene diol eluted with 1:1 CH₂Cl₂/acetone. The pentacene diol solution may then be concentrated under vacuum distillation, and the residue redissolved in acetone and MeOH. Tin(II) chloride dihydrate or similar is then added, and then 10% HCl(aq) solution added. The reaction mixture is stirred for 1 hour at room temperature and then quenched with H₂O. The product is then extracted with CH₂Cl₂. The organic solvent is next removed under vacuum distillation, and the crude product passed through a silica plug with hexanes. The is then collected, and after solvent removal, recrystallized from acetone.

### EXAMPLES

### Synthesis and Structural Characterization.

The syntheses of silylethyne-substituted heteroacenes are understood in the literature (see for example M. L. Tang, A. D. Reichardt, T. Siegrist, S. C. B. Mannsfeld, Z. Bao Chem. Mater. 2008, 20, 4669). To a solution of the desired heteroacene dissolved in anhydrous tetrahydrofuran at a concentration of 1.0-0.1 M, stirred under nitrogen and cooled to 0° C. is added 1.1 molar equivalents of a solution of lithium diisopropylamide (either purchased commercially from e.g. Sigma-Aldrich, or made by deprotonating diisopropylamine with n-butyllithium in the usual manner). After stirring at 0° C. for 2 hours, 1.2 molar equivalents of the desired electrophile (chloro silane, germane, stannane, or a ketone such as cyclopentanone) are added, and the solution is then allowed to warm to room temperature and stirred for 2-48 hours. The reaction mixture is poured into hexanes and extracted repeatedly with water. The organic solution is then dried (magnesium or sodium sulfate) and the solvent removed. The resulting molecule is purified by chromatography with silica gel, and then by recrystallization.

As a particular example, anhydrous tetrahydrofuran and lithium diisopropylamide were purchased from Sigma Aldrich. Chlorotriethylsilane was purchased from TCI. Hexanes and dichloromethane were purchased from VWR. Silica for chromatography (40-63 μm, 60 Å) was purchased from Silicycle. All purchased chemicals were used without further purification. Proton and carbon NMR spectra were collected using a 400 MHz Bruker spectrometer. Chemical shifts of each spectrum are reported in ppm and referenced to deuterated chloroform (Sigma Aldrich) solvent. HRMS was measured using a ThermoFisher Q-Exactive spectrometer by ESI in positive mode using a 10 μg/mL solution in 1:1 acetonitrile/water. TIPS-TT was prepared according to literature procedures (see, M. L. Tang, A. D. Reichardt, T. Siegrist, S. C. B. Mannsfeld and Z. Bao, Chem. Mater., 2008, 20, 4669). TES TIPS-TT was synthesized in one step from TIPS-TT.

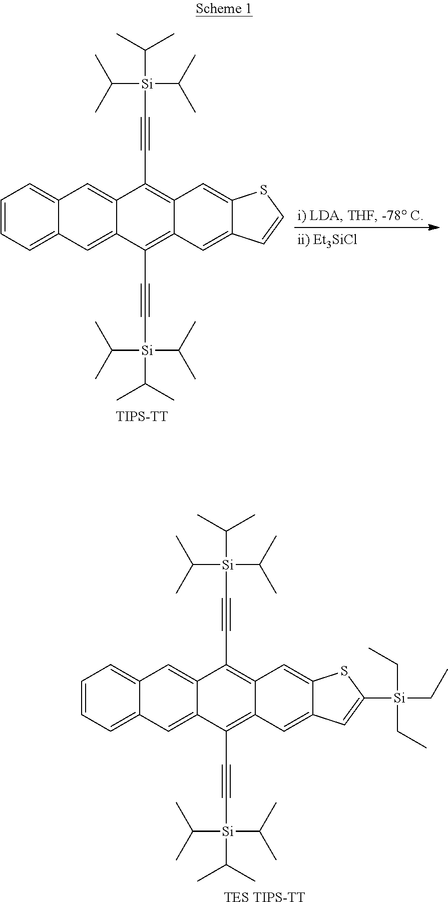

Briefly, TIPS-TT (0.25 g, 0.39 mmol) was dissolved in anhydrous THE (50 mL) and cooled to −78° C. Lithium diisopropylamide (1M in THF, 0.58 mL, 0.58 mmol) was added, and the mixture stirred for 15 minutes. Chlorotriethylsilane (0.098 mL, 0.78 mmol) was added, and the reaction stirred for 16 hours at room temperature. The reaction was quenched with H₂O (25 mL) and then 10% HCl solution (25 mL). The product was extracted with CH₂Cl₂ (50 mL) and washed with H₂O (50 mL). The solvent was removed and the crude product purified on silica (hexanes). Recrystallisation from acetone gave TES TIPS-TT as dark purple crystalline blocks (0.23 g, 78%)¹H NMR (400 MHz, CDCl₃) δ 9.32 (d, J=3.5 Hz, 2H), 9.17 (s, 1H), 9.11 (s, 1H), 8.00 (dd, J=6.5, 3.3 Hz, 2H), 7.51 (s, 1H), 7.44 (dd, J=6.5, 3.3 Hz, 2H), 1.35 (m, 42H), 1.09 (t, J=7.7 Hz, 9H), 0.95 (m, J=4.0 Hz, 6H). ¹³C NMR (100 MHz, CDCl₃) δ 144.6, 142.7, 141.8, 132.1, 132.0, 131.4, 130.4, 130.4, 130.3, 130.2, 128.6, 128.6, 126.2, 125.9, 125.8, 120.9, 119.3, 118.7, 117.3, 106.5, 106.1, 104.5, 104.5, 31.0, 19.0, 19.0, 11.7, 7.4, 4.0. HRMS (ESI, +ve) m/z C₄₈H₆₆SS₁₃ requires 758.41875 observed 758.4215.

X-ray diffraction data were collected at 90.0(2) K on a Bruker D8 Venture dual-source diffractometer with graded-multilayer focused MoK(alpha) X-rays. Raw data were integrated, scaled, merged and corrected for Lorentz-polarization effects using the APEX3 package. Corrections for absorption were applied using SADABS. The structures were solved by dual-space methods (SHELXT) and refined against F² by weighted full-matrix least-squares (SHELXL-2018). Hydrogen atoms were found in difference maps but subsequently placed at calculated positions and refined using riding models. Non-hydrogen atoms were refined with anisotropic displacement parameters. The final structure model was checked using established methods. Atomic scattering factors were taken from the International Tables for Crystallography. Additional crystal data and information on structure refinement can be found in the SI.

Dioxolane-pentacene synthesis was a 2 step process via a dioxolane-quinone. 2,2-isobutyl Anthra[2,3-d]-1,3-dioxole-6,9-dione [M. Bruzek and J. E. Anthony, Organic Letters (2014), 16(13), 3608-3610](1.50 g, 4.11 mmol) and α,α,α′,α′-Tetrabromo-o-xylene (1.74 g, 4.11 mmol) were dissolved in dimethylacetamide (10 mL) in a screw cap pressure tube. The reaction mixture was purged with N2 gas for 30 minutes, and then Potassium Iodide (2.73 g, 16.44 mmol) was added and the tube was sealed. The reaction mixture was stirred at 180° C. for 48 hours. At room temperature, the reaction was quenched with H2O (10 mL) the solid collected by vacuum filtration. The solid was washed with acetone (100 mL) and diethyl ether (50 mL). The solid was transferred to a round bottom flask and triturated with acetone (100 mL), and left to stand at room temperature for 48 hours. The solid was then collected by vacuum filtration, yielding a golden powder (0.430 g, 23%). Scheme 2 shows a summary.

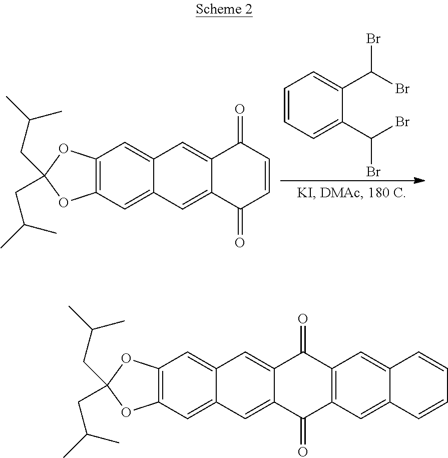

Next, triisopropylsilyl acetylene (0.97 mL, 4.31 mmol) was dissolved in hexanes (50 mL) and cooled to 0° C. with an ice bath. n-Butyllithium (2.5M, 1.38 mL, 3.44 mmol) was added slowly, and the reaction mixture stirred for 1 hour at 0° C. Dioxolane quinone (0.400 g, 0.86 mmol) was added, and the reaction stirred for 16 hours at room temperature. The reaction was quenched by addition of a few drops of saturated NH₄Cl(aq) solution, and the mixture poured onto a silica plug. The excess acetylene was eluted with hexanes, and then the pentacene diol was eluted with 1:1 CH₂Cl₂/acetone. The pentacene diol solution was concentrated under vacuum distillation, and the residue redissolved in acetone (50 mL) and MeOH (50 mL). Tin(II) chloride dihydrate (0.97 g, 4.31 mmol) was added, and then 10% HCl(aq) solution (10 mL) was added. The reaction mixture was stirred for 1 hour at room temperature. The reaction was quenched with H₂O (100 mL) and the product extracted with CH₂Cl₂ (100 mL). The organic solvent was removed under vacuum distillation, and the crude product passed through a silica plug with hexanes. The blue-green product was collected, and after solvent removal it was recrystallized from acetone to yield dark blue crystals (0.350 g, 51%). Scheme 3 provides an overview.

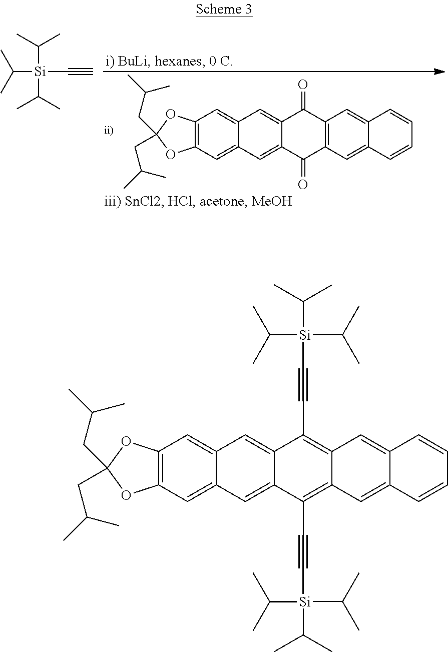

Magnetophotoluminescence. Columnar-shaped crystals were attached to glass substrates using silver adhesive and then positioned at the face of a 50-micron diameter multi-mode optical fiber. The fiber was one port of a 50:50 coupler linking the sample with the excitation and detection arms. Excitation was a filtered 519-nm diode laser operated below threshold giving an unpolarized power of 1 μW exiting the sample arm. PL collected there reached the detection arm where it was coupled through a 539-nm edge filter and into a 0.27-m spectrometer with a cooled charged-coupled device array. The sample arm was held in He vapor within a 2 K, 14 T magnet with the field oriented perpendicular to the sample's long axis.

Electron paramagnetic resonance spectroscopy. TR-EPR experiments at X-band (˜9.5 GHz) were performed using a Bruker Elexsys E-580 spectrometer equipped with an ER 4118X-MS3 resonator. The TIPS TES TT monomer triplet spectrum was collected from a sample consisting of the material dissolved in a 4:1 mixture of iodobutane and toluene prepared in the glovebox, temporarily sealed with a septum, frozen using liquid N₂, and then rapidly transferred to the EPR spectrometer held at 100 K to prevent oxygen from dissolving into the solvent matrix of the sample. The crystalline powder sample was prepared by placing glass capillaries coated with small amounts of crystalline powder into clear fused quartz (CFQ) EPR tubes, which were then flame-sealed under vacuum. Single crystal samples were mounted using the (0 1-1) or (0-1 1) faces to the end of CFQ rods cut at 380 to achieve the desired orientation. Spectra were collected after photoexcitation with 7 ns, ˜2.5 mJ pulses from an Opotek Radiant 355 LD laser system under constant irradiation with microwave power of 2.4 mW.

The monomer triplet spectrum of TES TIPS-TT, collected was fit using the pepper function in EasySpin a MATLAB package designed for the analysis of EPR spectra. Spin energy level diagrams were calculated using the levels function of EasySpin.

### Calculations

The molecular model of the di-TIPS-TES-thienotetracene molecule included all atoms out to the silicon atoms, with pendant alkanes replaced by hydrogen atoms. The experimental X-ray crystallographic structure showed partial occupancy for methenyl group and sulfur atomic positions in the thiophene ring, hypothetically arising from pseudosymmetric C₂ rotation about the long thienotetracene molecular axis. Thus, construction of a dimer model has an uncertainty due to the relative disposition of sulfur atoms, requiring calculation with both possible relationships. Geometries of the constructed silane hydrogen caps and the thiophene H₃Si—C1<(HC2)(S) end group where partial occupancy was evident were optimized using a UB97D/def2-TZVPP model chemistry with density fitting; all other atoms were kept at the crystallographically observed positions. Dimer exchange couplings were computed via broken-symmetry density functional theory using the SCAN functional and the triple-zeta def2-TZVPP atomic basis set. The SCAN meta-GGA functional was chosen for its maximal satisfaction of formal properties, as well as the reasonable energetic differences between broken-symmetry singlet and quintet dimer states. In order to assess its suitability for spin-spin energetics independently, zero-field splittings were also calculated across an organic test set of triplet diradicals and carbenes.⁷ Comparison data with the BP86 and B3LYP functionals, which performed favorably in the original benchmark work, are presented in Supplemental Table X. Overall, SCAN was found to perform comparably to these two functionals.

### Results

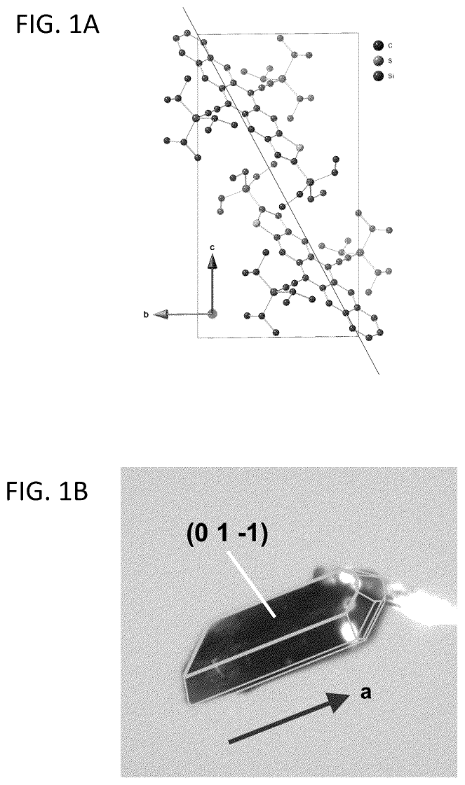

Structural characterization. Knowledge of the microscopic and macroscopic crystal properties of TES TIPS-TT (FIG. 1) enable a high level of control over molecular orientation relative to the applied magnetic field (B₀) in TR-EPR experiments.

The unit cell features two unique molecules of TES TIPS-TT that are nonetheless defined by a common molecular z′-axis direction, which simplifies both the spin dynamics of the SF exciton pair and interpretation of the associated TR-EPR spectra relative to an unaligned chromophore pair. In addition to the dimer observable in the unit cell that has the thiophene rings slightly eclipsed, each chromophore is also similarly coupled to another neighboring molecule, but with the thiophenes on opposite sides and the terminal phenyls partially eclipsed. This series of stacked dimer-like interactions continues in a quasi-one-dimensional fashion, while perpendicular to this direction there are two varieties of “side-by-side” dimers, which appear to be much more weakly coupled. While not likely to be the dominant sites for singlet fission due to the lack of strong orbital overlap, these nearly co-planar dimers may play a role in supporting weakly coupled triplet pairs upon diffusion and nongeminate encounters.

TES TIPS-TT forms lath-shaped crystals with a clearly identifiable long axis and a parallel set of two large faces. The results obtained from indexing several crystals indicated that the long axis corresponds to the a-axis, and the large faces correspond to the (0 1-1) and (0-1 1) planes of the unit cell. By considering this information in combination with the orientation of the molecules within the unit cell, it was determined that the molecular z′-axes of all chromophores within a single crystal sample could be aligned with B₀ by mounting the crystal to quartz rods cut at 38°, as shown in the SI. Rotation of the EPR sample rod would permit careful control of the orientation of both the x′- and z′-axes within the plane of B₀, while the y′-axis would remain perpendicular.

### Exchange Energy Calculations.

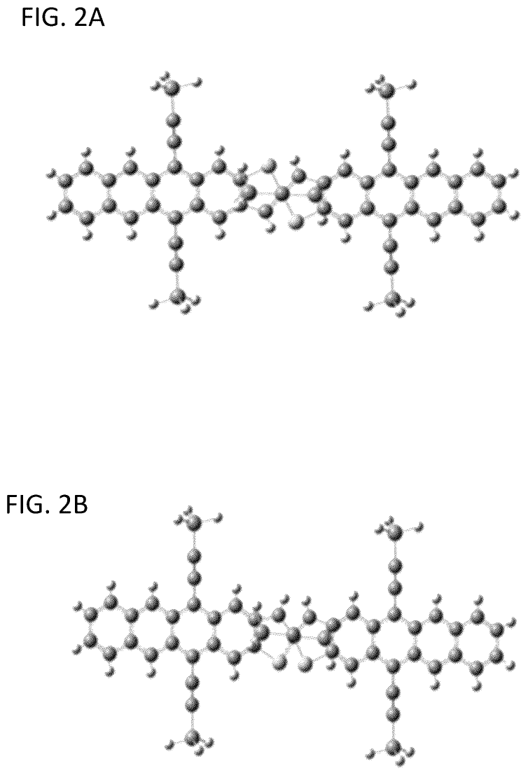

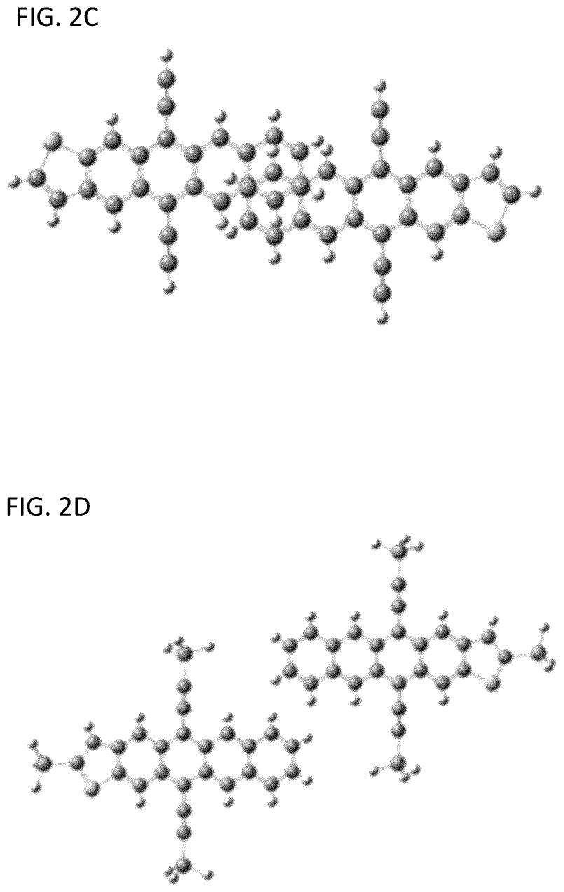

Table 1 shows calculated exchange couplings for three dimer models, set forth in FIG. 2. Dimer 1 has sub-models “a” and “b” depending on whether sulfur positions were modeled on the opposite or same sides, respectively, of a plane encompassing the long molecular axes of the dimer pair.

TABLE 1
SCAN/def2-TZVPP calculated exchange couplings
for di-TIPS-TES-thienotetracene dimers.

| Dimer model | Calculated exchange coupling (cm⁻¹) |
|---|---|
| 1a | −2.3 |
| 1b | 0.98 |
| 2 | 21 |
| 3 | 0.0 |

Dimers a and b showed similar coupling magnitudes, but of opposite state ordering, with the sulfur atoms on the “opposite” sides of an imaginary plane along the molecular long axes leading to a higher energy quintet state (i.e., antiferromagnet coupling). Dimer model b shows a ferromagnetic coupling of a comparable magnitude to that observed experimentally. Dimer c involves the interaction between the distal tetracene ends as opposed to the thiophene ends of the ring system in dimer a-b. Visually in FIG. 2, this spatial overlap seems more extensive in area, and may help to explain the larger exchange coupling calculated. Dimer d is a “side-by-side” dimer model from the crystal structure, which shows scant exchange splitting between the broken-symmetry singlet and quintet states (the raw energy difference was calculated to be 5.5 nanoHartrees, versus over 300× that for dimer b).

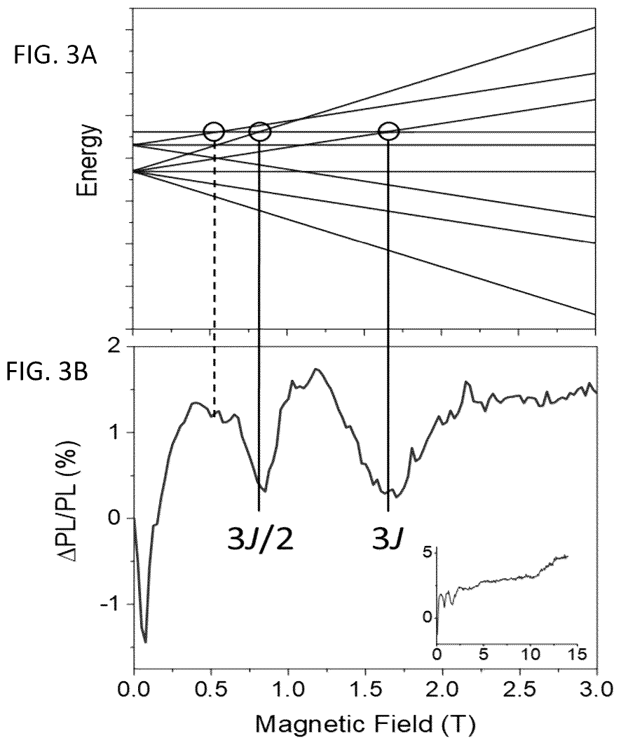

Magnetophotoluminescence. Single crystals of TES TIPS-TT exhibit delayed fluorescence, the yield of which is dependent on the strength of an applied magnetic field (FIG. 3). These data are similar to those obtained from a previous experiment performed on TIPS tetracene, for which three peaks were observed at field strengths sufficient to facilitate mixing between the emissive, non-magnetic ¹(TT) state and the dark ³(TT)₋₁, ⁵(TT)₋₂, and ⁵(TT)₋₁ states, which change in energy through the magnetic Zeeman interaction. However, in contrast to TIPS tetracene, the TES TIPS-TT data only shows two prominent resonances resulting in lower fluorescence yield, at approximately 1 and 2 T. Based on the ratios of the associated magnetic field strengths, and since ¹(TT)-³(TT) mixing is forbidden when chromophores are aligned, the first and second peaks can be assigned to mixing between ¹(TT) and ⁵(TT)₋₂ and ⁵(TT)₋₁, respectively. As the magnitude of the exciton pair's spin-spin exchange interaction J dictates the splitting between the ¹(TT), ³(TT), and ⁵(TT) manifolds, the observed peak positions define a value of |J|=15 GHz for at least one dimer within the TES TIPS-TT crystal structure. It should be noted that the multitude of possible molecular pairs will lead to other values of |J|; however, these may not be observable in the magneto-PL experiment because triplet-triplet interactions on these pairs do not lead to delayed fluorescence, or they are too weak or too strong and fall outside of the magnetic field range of the experiment (which would detect values of |J| between 1 and 400 GHz).

Electron paramagnetic resonance spectroscopy. TR-EPR spectra of TES TIPS-TT in a 4:1 mixture of iodobutane and toluene after □ₑₓ=600 nm were collected at 100 K (4a). The heavy atom effect from the solvent encourages intersystem crossing (ISC) in TES TIPS-TT, allowing the monomer triplet to be characterized. Fitting the extracted ³*(TES TIPS-TT) spectrum using the EasySpin software package indicated zero field splitting (zfs) parameters of D=1271 MHz and E=−0.4 MHz. These parameters represent the axial (z′) and transversal (x′, y′) components of the spin dipole-dipole interaction within a single triplet exciton and provide information on where the various EPR transitions associated with ³(TT), ⁵(TT), and (T+T) are expected to appear for specific molecular orientations relative to B₀. As it will be relevant to the following discussion, it is worth noting that, although ISC populates the three triplet substates differently depending on molecular orientation vs. B₀, the two prominent peaks observed in a triplet powder spectrum (e.g. around 325 and 370 mT) are associated with the statistically most likely z′⊥B₀ orientation.

TR-EPR spectra obtained from a crystalline powder of TES TIPS-TT at room temperature after □ₑₓ=610 nm are shown in 4b. The first spectrum, obtained by averaging the spectral traces between 25-75 ns, is representative of the early spin evolution and is more complex relative to the ³*(TES TIPS-TT) spectrum. Most distinctively, there is a pair of peaks, one emissive and one absorptive, split from each other about center field with a magnitude of D/3. Such peaks are characteristic of transitions from the ⁵(TT)₀ state, and suggest that (TT) pairs from SF are present for approximately the first 100 ns of the TR-EPR experiment. The intensity of the additional peaks suggests possible contributions from other transitions within the ⁵(TT) manifold, as well as from ³(TT) and/or (T+T). The second spectrum, obtained by averaging the traces between 400-450 ns and representative of the spectra collected at later times, lacks the ⁵(TT) peaks, and is almost certainly shows isolated triplets or diffuse triplet pairs (T+T), which are not distinguishable by TR-EPR.

Several qualitative observations can be made about these spectra. As in the ³*(TES TIPS-TT) spectrum, there is a distinct peak observable at ˜325 mT in both the early and late time spectra. Considering the previously obtained zfs parameters, previous observations in tetracene derivatives,⁸ and the peak's absorptive character, this peak could be assigned to several different transitions, including ⁵(TT)₋₂→⁵(TT)₋₁, ³(TT)₀→³(TT)₊₁, and T₋₁→T₀. No matter its specific assignment, one would expect a matching emissive peak at ˜370 mT based on typical SF spin polarization mechanisms, but this is not observed at early or late times. In fact, there is a dominance of positive/absorptive features across the spectra, especially at late times. This is somewhat unusual, as SF within strongly exchanged, well-aligned dimers is expected to populate states symmetrically, e.g., population of ⁵(TT)₊₂ should result in equal population of ⁵(TT)₋₂. Similar preferential populations of the lower mₛ sublevels has been observed previously and was assigned to a mechanism involving fluctuations in J due to (TT) diffusion and refusion in tetracene and pentacene aggregates by Nagashima, et al, (J. Phys. Chem. Lett., 2018, 9(19): 5855-5861) and to a relatively low value of J leading to ⁵(TT)/³(TT) mixing at EPR field strengths in a terylenediimide dimer by Chen, et al. (Proc. Natl. Acad. Sci U.S.A., 2019, 116(17): 8178-8183).

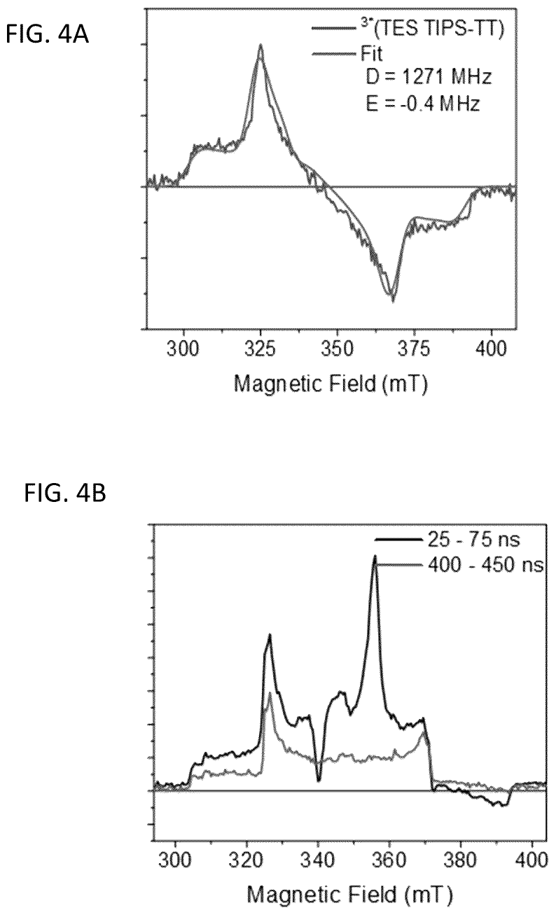

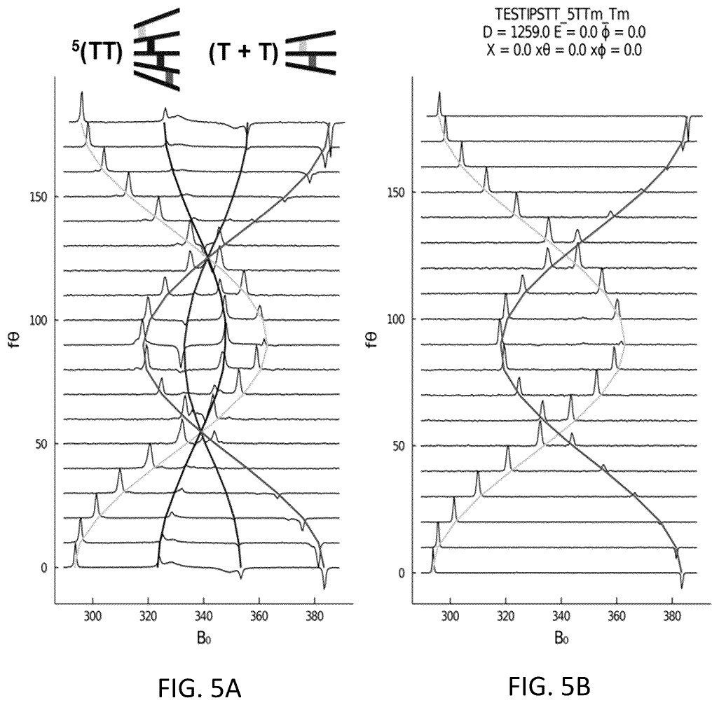

A single crystal of TES TIPS-TT was mounted as to make the orientation z′∥B₀ attainable within the EPR spectrometer. Starting with this orientation (labeled 00), the sample was rotated to collect TR-EPR spectra for different orientations of the z′-axis in 100 increments between 0 and 1800 (5 and SI). Whereas the orientation of the z′-axis is considered to have the largest effect on both the SF spin dynamics and energy splitting of the relevant transitions, it should be emphasized that rotation takes place in the x′z′-plane, so that the y′-axis is perpendicular to the field at all orientations, and the spectrum taken at 900 is associated with both z′⊥B₀ and x′|B₀. FIG. 4 also shows lines corresponding to the transitions calculated for two triplet excitons defined by the previously obtained zfs parameters that are strongly coupled (i.e. J is sufficiently large so that the ^{1,3,5}(TT) manifolds do not interact for the field range under consideration).

The single crystal TR-EPR spectra are more complex at early times-they feature up to four prominent peaks, which are sometimes significantly broadened and include smaller side peaks. Near z′|B₀ and x′|B₀ (0 and 90°, respectively), the two transitions from ⁵(TT)₀ are easily observable. There are other orientations (50 and 120°) with a large degree of expected overlap between transitions from which it is difficult to draw immediate conclusions upon inspection. However, one salient observation emerges in the remaining spectra. Whereas the ⁵(TT)₀→⁵(TT)₊₁ transition shows at least some amplitude in all other orientations, the ⁵(TT)₀↔⁵(TT)₋₁ transition is often missing or is even associated with an absorptive/positive peak. These observations indicate an unexpected polarization at these orientations, e.g., a population of the ⁵(TT)₋₁ state equal to or greater than that of ⁵(TT)₀. As noted earlier, the crystalline powder spectra also exhibit a similar trend towards population of the lower energy mₛ sublevels.

The spectra at later times are far simpler and feature no more than two peaks. These peaks align well with the calculated transitions for an isolated triplet or (T+T) and show none of the broadening seen at early times. These facts support that the sample is indeed a single crystal and that it is oriented in the prescribed fashion. The broadening at early times is discussed in the following section. As a final observation, it should be note that the peaks at later times also appear in the earliest spectra, albeit with occasional changes in polarization and linewidth narrowing. This suggests that a population of weakly exchange coupled triplets (T+T) may already be present at the earliest times probed by the TR-EPR experiment.

### Discussion

The TES TIPS-TT powder and single crystal TR-EPR spectra are more complex than expected for a material that forms well-aligned dimer pairs. There are three interrelated features of the system that make analysis more difficult. First, the data suggest that the spectra are not composed of a simple, sequential evolution from ⁵(TT) to (T+T), but instead an equilibrium ⁵(TT)↔(T+T). Secondly, the populations as indicated by the relative signs and intensities of the observed TR-EPR transitions are asymmetric at most orientations, likely due to the involvement of exciton pairs with weak or intermediate coupling J Thirdly, the TR-EPR peaks in peaks associated with (TT) pairs show an unusual broadening. Each of these points will be discussed in the following sections.

Kinetics. As mentioned in above, the single-crystal TR-EPR spectra generally show a complex set of peaks within approximately the first 100-200 ns, which at later times yields to spectra just showing two well-defined peaks. At all orientations, the well-defined peaks observable at late times are consistent with transitions involving dissociated triplet excitons (T+T) and are also observed at early times with some change in intensity. It is therefore likely that early time spectra consist of contributions from both ⁵(TT) and (T+T).

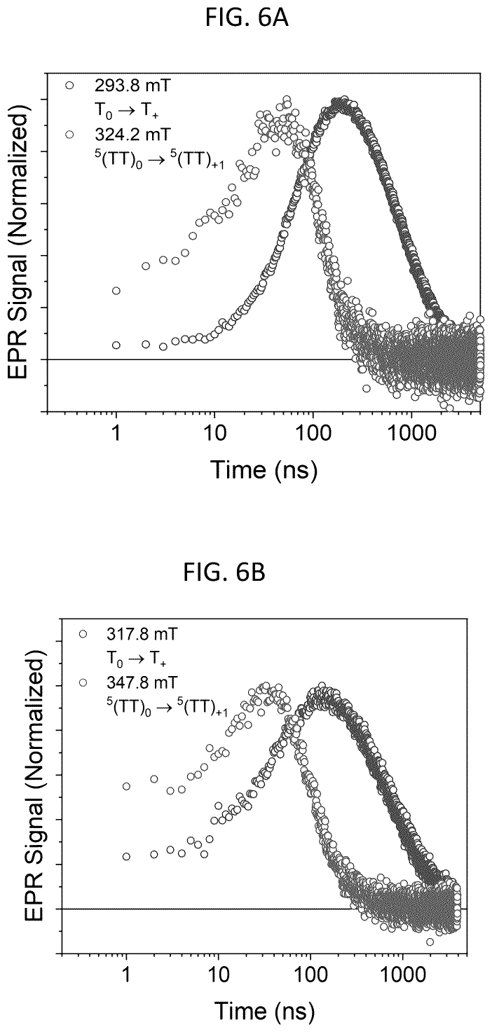

SF is far more likely to occur in dimers with strong coupling mediated by □-□ stacking. Though the crystal structure of TES TIPS-TT indicates there are four unique dimers with this geometry, and calculations indicate a variety of J values among these pairs, it is unlikely that these primary exciton pairs exhibit a large change in the rate of dissociation from ⁵(TT) to (T+T). In fact, as all varieties of these □-□ stacked dimers can be found within the same extended “staircase” within the crystal structure, rapid interconversion between dimer varieties seems likely as a (TT) pair migrates between different sites. Taking this into account, it seems less probable that the concurrence of ⁵(TT) and (T+T) features are due to parallel processes, where some (TT) pairs dissociate rapidly (within the ˜20 ns resonator response of the TR-EPR experiment) while others persist for □≈100 ns. Instead, the possibility may be that the early time signals are representative of the equilibrium ⁵(TT)↔(T+T), with the disappearance of ⁵(TT) features associated with a loss of spin coherence and decrease in exciton density leading to less re-fusion events (FIG. 6).

As an example of this behavior, the spectra of z′|B₀ (FIG. 6A) is analyzed in more detail as the transitions are well-resolved. The early time spectrum obtained from averaging the traces between 25-75 ns includes four sharp peaks (the broader features will be discussed later) with an aaee (absorptive/emissive) polarization pattern. The two central ae peaks, considering both sign and field position, can be unambiguously assigned to transitions from ⁵(TT)₀ to ⁵(TT)₊₁ and ⁵(TT)₋₁, respectively. Based on field position, the outer peaks could be assigned to transitions ⁵(TT)_{±1}→⁵(TT)_{±2}, ³(TT)_{±1}→³(TT)₀, or within (T+T). However, these peaks maintain the same polarization at later times (400-450 ns), at which point it seems all (TT) pairs have diffused to (T+T) selectively populated in the |00 [symbol] state.

Spin sublevel populations. While it appears the general description of z′|B₀ applies to the spin evolution at all orientations to some degree, analysis of the spin sublevel populations at the other orientations are not as straightforward. Generally, the various spectra show a preferential population of the lower energy spin sublevels, even for the ⁵(TT) pairs at early times, which leads to predominately absorptive spectra. Models of SF within strongly exchanged dimers predict that initial spin sublevel population of ⁵(TT) occurs symmetrically at all orientations, e.g., for any population of ⁵(TT)₊₂, there will be an equal population of ⁵(TT)₋₂. Such models have been used successfully in many situations so far, so it is unlikely that they are incorrect. Instead, the observation of asymmetric ⁵(TT) spectra lends further support to the idea that the TR-EPR data are showing ⁵(TT) pairs that have re-formed after diffusion to sites with values of J of varying magnitude and sign, and that the diffusion of the initial (TT) pairs is rather fast.

The MPL data indicate |J|=15 GHz for at least one exciton pair, an intermediate coupling strength that results in mixing between the ⁵(TT) and ³(TT) spin manifolds within the magnetic field range of X-band EPR (˜350 mT). Assuming a negative value of J, this results in a level crossing between ⁵(TT)₊₂ and ³(TT)₋₁ at 360 mT for x′|B₀—very close to where transitions involving these states are expected to appear. The combination of overlapping transitions and level crossing explains the unusual character of the x′|B₀ spectra at early times (FIG. 6B). Also, the predicted initial population of ⁵(TT)₊₂ funneled to ³(TT)₋₁ which rapidly dissociates to (T+T) with a preferential population of |− [symbol] can explain the two absorptive (T+T) peaks at late times.

Conclusions. This example is a direct look at the spin dynamics of a coupled exciton pair in the novel material TES TIPS-TT, which forms crystals with exceptional macroscopic ordering. Crystals of TES TIPS-TT also exhibit a somewhat rare magnetic field dependent delayed fluorescence, which allows for direct measurement of the electronic coupling between at least one dimer pair. By systematically examining the TR-EPR spectra at various orientations of a single crystal, the dependence of spin evolution on molecular orientation relative to applied magnetic field has become clear. These experiments have also provided a glimpse of additional effects that would be difficult to analyze in a typical powder sample experiment, such as the broadening of certain peaks associated with ⁵(TT). The observation of MPL and TR-EPR spectra indicating the presence of ⁵(TT) also suggest that TES TIPS-TT may be an interesting candidate for optically detected magnetic resonance experiments.

### ODMR

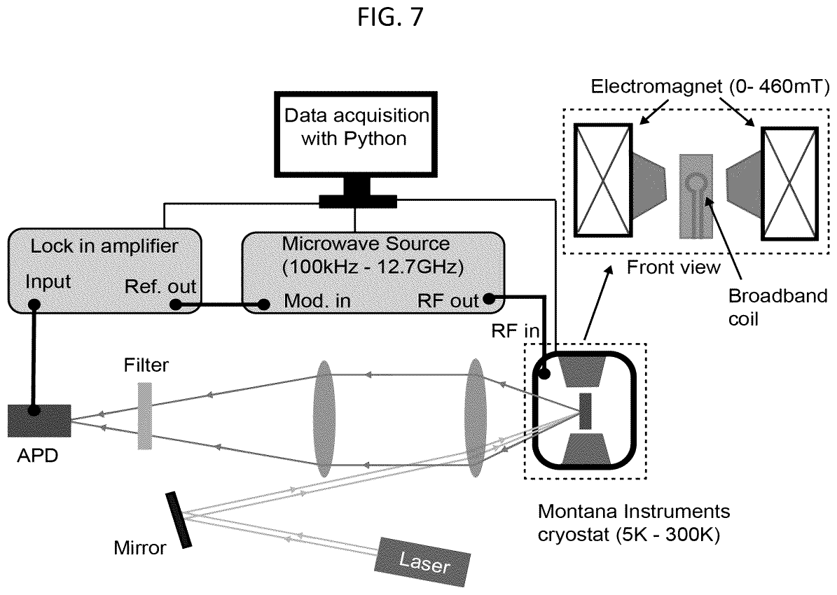

This portion contains brief discussion of optically detected magnetic resonance (ODMR) of TES-TIPS TT powder sample at low temperature. The experimental setup is shown in FIG. 7.

The sample is mounted on the home-built sample holder that is bolted to the cold-finger of Montana Instruments cryostat. The cryostat cools down to 5K with closed loop helium cooling system. The cryostat consists of two pole pieces that can provide static magnetic field (B₀) from 0-460 mT. The broadband coil is attached close to the sample such that microwave magnetic field (B₁) is perpendicular to static field (B₀). The sample is optically excited by relatively low power laser beam of wavelength 532 nm. The photoluminescence is collected by lens assembly outside of cryostat. The avalanche photodiode (APD) converts the optical signal into electrical voltage which is then fed to the lock-in amplifier. Microwave power is modulated at 100 Hz to detect the ODMR signal by lock-in detection scheme. A python program controls the devices and automates the experiment.

Photoluminescence Spectra from the Powder TES-TIPS TT

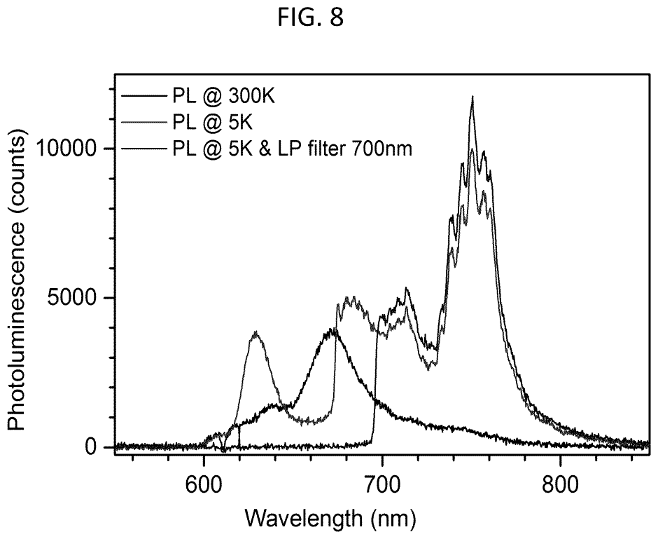

The sample undergoes different spectral transitions and new features emerges depending on the temperature of sample. The initial room temperature spectra are red shifted at low temperature and new emission band with sharp spectral features appears at higher wavelength side of spectrum. FIG. 8 compares the spectral features at room temperature and low temperature. The new emission band that peaked at 750 nm is due to the singlet fission process. Therefore, in order to probe the spin dynamics and nature of spin species generated in singlet fission process the magnetic resonance experiment is carried out with long pass filter at 700 nm.

### ODMR at Zero-Field

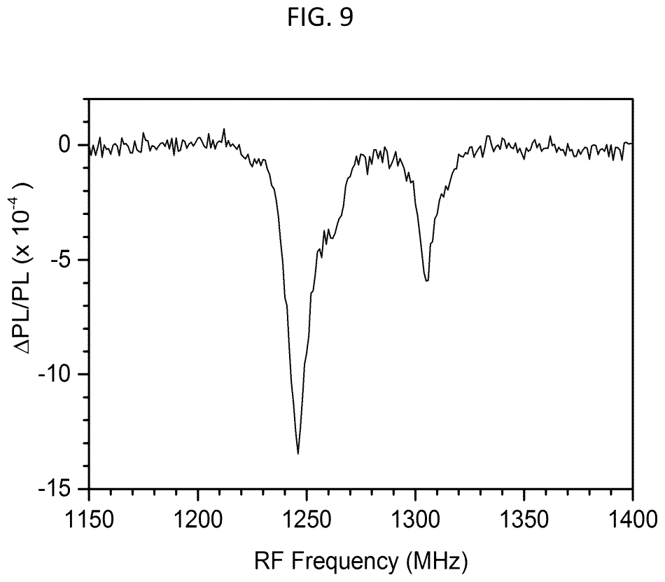

The observation of zero-field ODMR unambiguously determines the zero-field splitting parameters D and E. The planar loop coil for microwave excitation can be used at arbitrary microwave frequency. In order to obtain ODMR at zero external field, the microwave frequency is swept at source power about 20 dBm and the data acquired by lock-in detection scheme. The microwave amplitude is modulated at 100 Hz. The two prominent peaks near 1250 MHz and 1300 MHz gives the information about D and E. But there is a small feature around 1260 MHz that is convoluted in the strong transition around 1250 MHz as seen in FIG. 9. Although a careful analysis of spectra in combination with other intermediate ODMR is necessary to figure out the nature of interaction and type of spin species.

### ODMR at 3 GHz

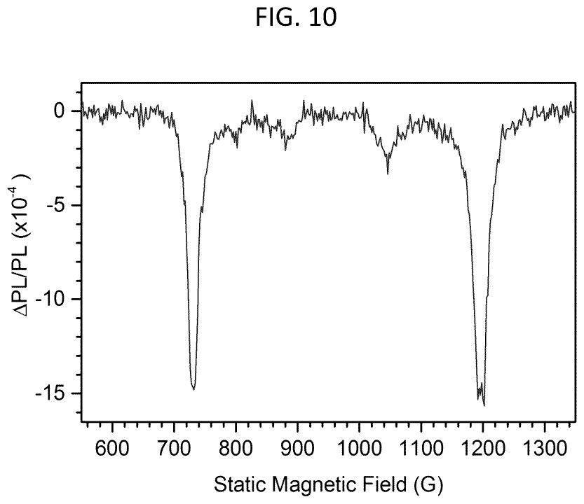

The cw ODMR spectra taken at 3 GHz frequency by sweeping static magnetic field over a broad range reveals several resonant features as in FIG. 10. Some of them are strong transitions and others show weak transition. A more detail study is needed to reveal the nature of spin species that gives these transitions.

### Magnetic Field Effect on PL

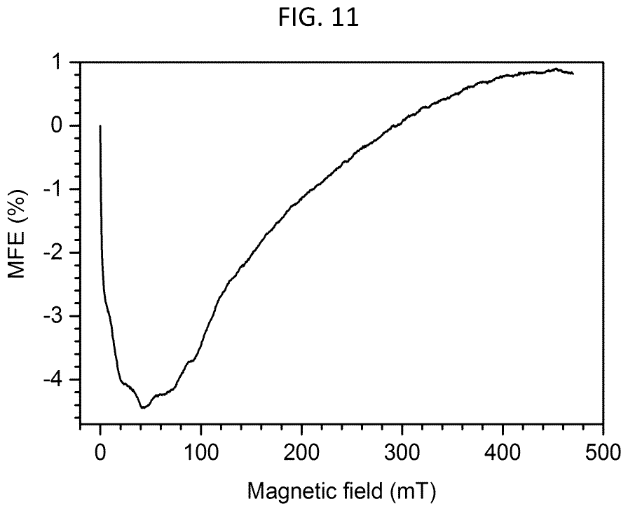

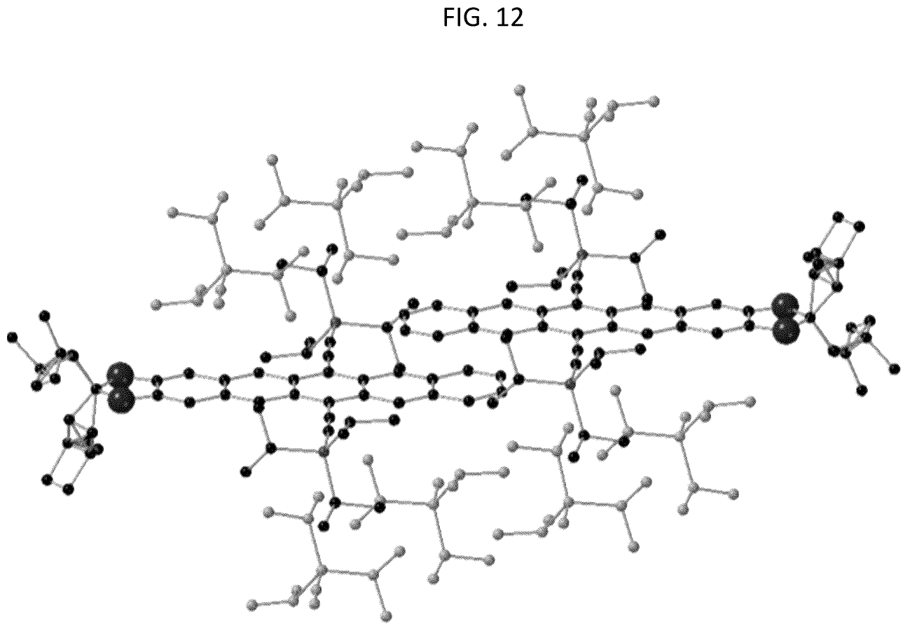

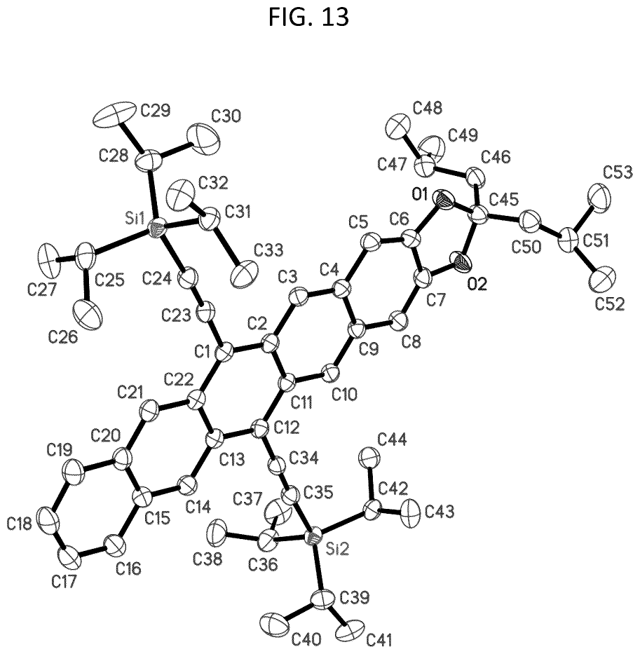

One very commonly used technique to determine the nature of spin species involved in the photoluminescence process and the nature of interaction between them can be revealed by observing magnetic field effect over the broad range. Here magnetic field effect data were collected by using lock-in detection scheme to improve signal to noise. The laser excitation is modulated by a chopper at 80 Hz and the PL intensity is recorded as a function of magnetic field. The MFE curve shown in the FIG. 11 qualitatively resembles with the magnetic field effect in other materials that undergoes singlet fission.

1. A crystalline paired compound, comprising a first compound and a second compound, wherein the first compound comprises a molecule of Formula I or Formula II: 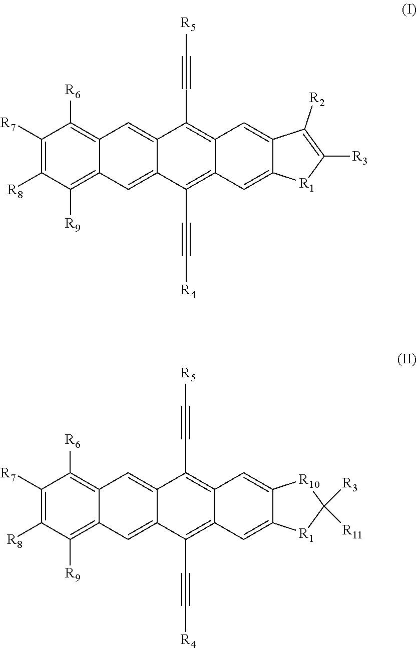
wherein:
R₁ and R₁₀ are independently selected from C, O, S, Se, and N;
R₃ and R₁₁ are independently selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl; and
R₈ is selected —H, —F, —Cl, —Br, —I, or OR₁₂.

2. The crystalline paired compound of claim 1, wherein the molecule comprises an additional benzene.

3. The crystalline paired compound of claim 2, wherein the first compound is of Formula (IA) or (IIA):

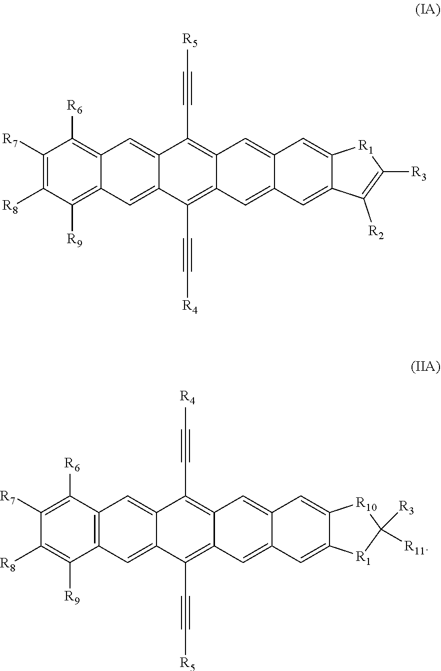

4. The crystalline paired compound of claim 1, wherein the first compound is selected from Formula I or IA.

5. The crystalline paired compound of claim 4, wherein:
R₁ is selected from C, O, S, Se, and N;
R₂ is selected from —H, —F, —Cl, —Br, —I, and CH₃
R₃ is selected from —H, an alkyl, an aryl, a vinyl, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), and an aryl group or functional aryl group of a phenyl, a naphthyl, a thienyl, a furnayl, a trialkylsilyl, a trialkylgermyl, a trialkylstannyl, or a tert-butyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, an alkyl carbinol or ether thereof, a trialkylsilyl, a trialkylgermyl, and a trialkylstannyl; and
R₈ is selected —H, —F, —Cl, —Br, or —I,

6. The crystalline paired compound of claim 4, wherein R₃ is a triethylsilyl, a triethylgermyl, or a triethyl stannyl.

7. The crystalline paired compound of claim 4, wherein R₃ is a triethylsilyl, a triethylgermyl, or a triethyl stannyl and R₆, R₇. R₈, and R₉ are hydrogen.

8. The crystalline paired compound of claim 4, wherein R₃ is a triethylsilyl, a triethylgermyl, or a triethyl stannyl; R₂, R₆, R₇. R₈, and R₉ are hydrogen; and R₁ is O or S.

9. The crystalline paired compound of claim 4, wherein R₄ and R₅ are triisopropylsilyl, triisopropylgermyl, or triisopropyl stannyl.

10. The crystalline paired compound of claim 4, wherein R₃ is a triethylsilyl, a triethylgermyl, or a triethyl stannyl; R₂, R₆, R₇. R₈, and R₉ are hydrogen; R₁ is O or S; and R₄ and R₅ are triisopropylsilyl, triisopropylgermyl, or triisopropyl stannyl

11. The crystalline paired compound of claim 1, wherein the first compound is selected from Formula II or IIA.

12. The crystalline paired compound of claim 11, wherein:
R₃ and Ru are independently selected from a straight alkyl, a branched alkyl an aryl, or a vinyl group;
R₄ and R₅ are chosen from a trialkylsilyl, a trialkylgermyl, a trialkylstannyl, or a tert-butyl group;
R₆, R₇, R₈, and R₉ are independently chosen from —H, —F, —Cl, —Br, —I, or OR₁₂, wherein R₁₂ is an alkyl chain of between 1 and 6 carbons in length.

13. The crystalline paired compound of claim 11, wherein R₃ and Ru are isobutyl.

14. The crystalline paired compound of claim 11, wherein R₃ and Ru are isobutyl and R₆, R₇. R₈, and R₉ are hydrogen.

15. The crystalline paired compound of claim 11, wherein R₄ and R₅ are triisopropylsilyl, triisopropylgermyl, or triisopropyl stannyl.

16. The crystalline paired compound of claim 11, wherein R₄ and R₅ are triisopropylsilyl, triisopropylgermyl, or triisopropyl stannyl; R₃ and Ru are isobutyl; and, R₆, R₇. R₈, and R₉ are hydrogen.

17. The crystalline paired compound of claim 1, wherein if R₃ is hydrogen, then R₇ is selected from a small branched alkyl, an alkyl carbinol or ether thereof, a trialkylsilyl, a trialkylgermyl, and a trialkylstannyl.

18. The crystalline paired compound of claim 1, wherein the second compound is identical to the first compound

19. The crystalline paired compound of claim 1, wherein the second compound comprises Formula III: 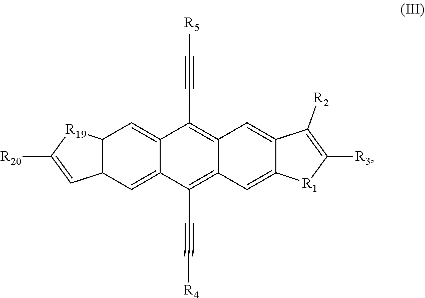
wherein:
R₁ and R₁₉ are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and
R₂₀ is selected from —H, —F, —Cl, —Br, and —I.

20. A crystalline paired compound comprising a first compound and a second compound, wherein the first compound comprises a molecule of Formula III or IIIA: 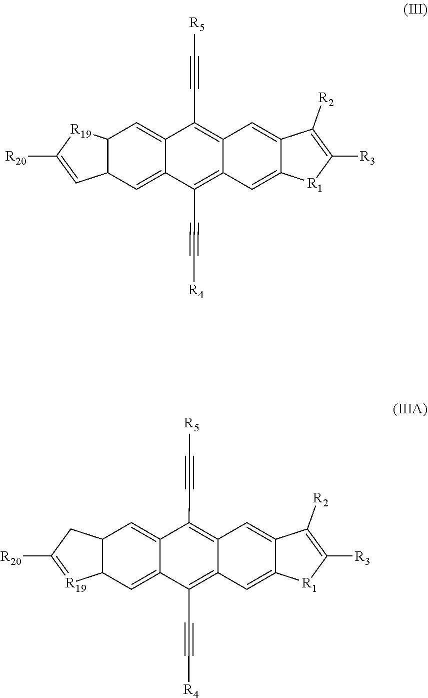
wherein:
R₁ and R₁₉ are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₄ and R₅ are independently selected from a straight alkyl chain (C₄-C₁₂), a branched alkyl chain (C₄-C₁₂), a trialkylsilyl, a trialkylgermyl, and an aryl group or functional aryl group of a phenyl, a naphthyl, a thienyl, or a furnayl; and
R₂₀ is selected from —H, —F, —Cl, —Br, and —I.

21. The crystalline compound of claim 20, wherein the second compound is of Formula IIIA if the first compound is of Formula III.

22. The crystalline compound of claim 20, wherein the second compound is of the same formula as the first compound.

23. A crystalline paired compound comprising a first compound and a second compound, wherein the first compound comprises a molecule of Formula IV, V, or VI: 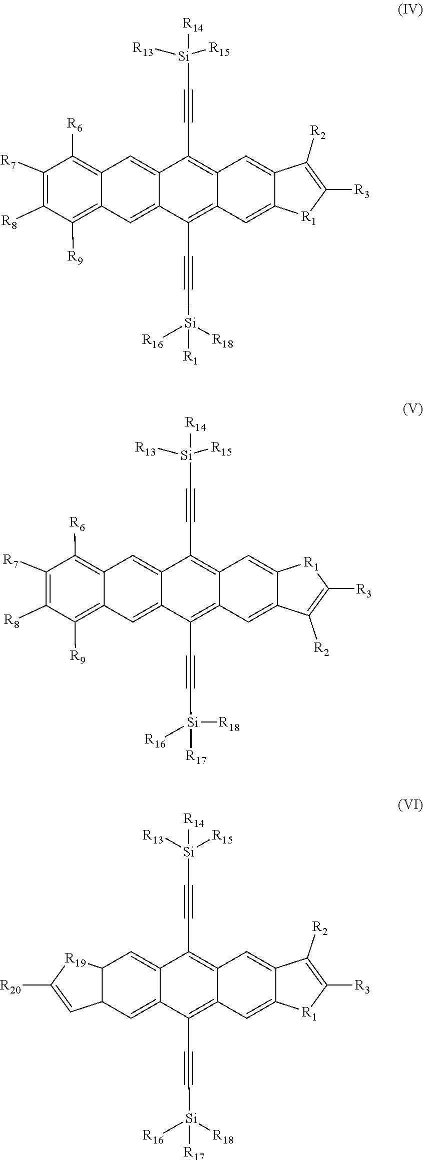
wherein:
R₁ and Rig are independently selected from C, O, S, Se, and N;
R₂ is selected from —H, —F, —Cl, —Br, —I, and CH₃
R₃ is selected from —H, a branched alkyl (C₄-C₁₂), an alkyl carbinol (C₄-C₁₂) or ether thereof, a trialkylsilyl, a trialkylgermyl, or a trialkylstannyl group;
R₆ and R₉ are independently selected from H, —F, —Cl, —Br, —I, —OH, and —OR₁₂, wherein R₁₂ is an alkyl chain of between 1 and 6 carbons in length;
R₇ is selected from —H, —F, —Cl, —Br, and —I, a small branched alkyl, —OR₁₂, an alkyl carbinol or ether thereof, a trialkylsilyl, a trialkylgermyl, and a trialkylstannyl;
R₈ is selected —H, —F, —Cl, —Br, —I, or OR₁₂; and,
R₁₃, R₁₄, R₁₅, R₁₆, R₁₇, and R₁₈ are independently selected from a straight alkyl (C₄-C₁₂) and a branched alkyl (C₄-C₁₂), or a combination thereof.

24. The crystalline compound of claim 23, wherein at least one of R₁₃, R₁₄, R₁₅, R₁₆, R₁₇, and R₁₈ is an isopropyl.

25. The crystalline compound of claim 23, wherein all of R₁₃, R₁₄, R₁₅, R₁₆, R₁₇, and R₁₈ are isopropyl.

26. The crystalline compound of claim 23, wherein R₃ is a triethylsilyl, a triethylgermyl, or a triethyl stannyl.

27. The crystalline paired compound of claim 23, wherein R₃ is a triethylsilyl, a triethylgermyl, or a triethyl stannyl and R₆, R₇. R₈, and R₉ are hydrogen.

28. A crystalline paired compound comprising a first compound and a second compound, wherein the first compound comprises a molecule of Formula VIII:

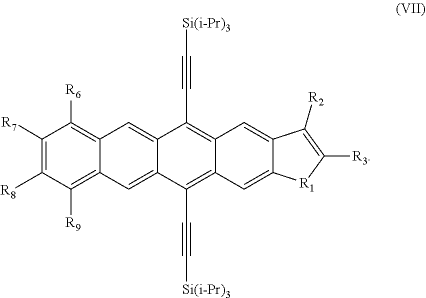

29. The crystalline compound of claim 28, wherein R₃ is a triethylsilyl, a triethylgermyl, or a triethyl stannyl.

30. The crystalline paired compound of claim 28, wherein R₃ is a triethylsilyl, a triethylgermyl, or a triethyl stannyl and R₆, R₇. R₈, and R₉ are hydrogen.

31. The crystalline paired compound of claim 28, wherein the first compound comprises Formula VIII:

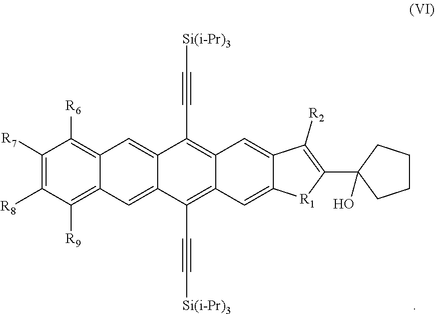

32. A crystalline paired compound, comprising a first compound and a second compound, wherein the first compound comprises a molecule of Formula IX or X: 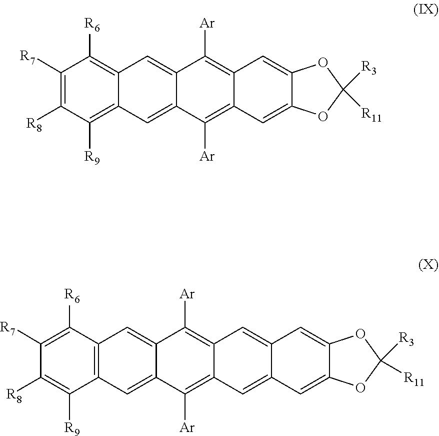
wherein:
R₁ and R₁₀ are oxygen;
R₃ and R₁₁ are independently selected from a straight alkyl, a branched alkyl, an aryl, or a vinyl group;
Each Ar is independently chosen from a functionalized aryl or heteroaryl group; and
R₆, R₇, R₈, and R₉ are independently chosen from —H, —F, —Cl, —Br, —I, or OR₁₂, wherein R₁₂ is an alkyl chain of between 1 and 6 carbons in length.

33. A molecular-based quantum bit (qubit) system comprised of any crystalline compound pair of claims 1-32.
